(19) United States
(12) Patent Application Publication
(10) Pub. No.: US 2015/0145483 A1
(43) Pub. Date: May 28, 2015

(54) DEVICE OF CONTROLLING CHARGE AND DISCHARGE OF BATTERY, METHOD AND STORAGE MEDIUM

(71) Applicant: Fujitsu Limited, Kawasaki-shi (JP)

(72) Inventors: Masako Shinohara, Yokohama (JP); Masahiko MURAKAMI, Kawasaki (JP)

(21) Appl. No.: 14/529,708

(22) Filed: Oct. 31, 2014

(30) Foreign Application Priority Data
Nov. 25, 2013 (JP) 2013-242802

(51) Int. Cl. H02J 7/00

(52) U.S. Cl. CPC H02J 7/007; H02J 7/0052
USPC 320/134

(57) ABSTRACT

A device of controlling a charge and discharge of a battery, the device includes, a storing device configured to store a plurality of charge and discharge control plans and an unplanned use history list, and a control device configured to acquire the charge and discharge state of a first battery, compares acquired charge and discharge state with the charge and discharge state defined in the charge and discharge control plan, detects a first unplanned use, estimates duration time and charge and discharge state of the first unplanned use based on the unplanned entry corresponding to the first unplanned use, corrects the charge and discharge control plan of the first battery so as to have the estimated charge and discharge state in estimated duration time, and corrects the charge and discharge control plan of a second battery, which has the estimated charge and discharge state in the estimated duration time.

### CROSS-REFERENCE TO RELATED APPLICATION

This application is based upon and claims the benefit of priority of the prior Japanese Patent Application No. 2013-242802, filed on Nov. 25, 2013, the entire contents of which are incorporated herein by reference.

### FIELD

The embodiments discussed herein are related to a device of controlling a charge and discharge of a battery, a method of controlling a charge and discharge of a battery and a storage medium.

### BACKGROUND

In recent years, it is viewed as suspicion that supply of the electricity is inadequate when a power station stopped in accidents by a large-scale disaster, and the energy saving regulation is reviewed to a direction of reduction of a peak electricity from total electric energy. Therefore, it is expected that the structure that consumers have a battery and effectively control a charge and discharge of the battery, becomes important. That is, it becomes important to control the charge of the electricity in a battery during a little amount of the electricity demand, and the discharge of the battery at a peak hour.

The battery is defined as having a function to save electricity and a function to use the saved electricity. For example, the battery includes not only the battery of stationary type to generally say but also EV (Electric Vehicle) and a notebook PC (Personal Computer) equipped with a built-in battery. In addition, the large-scale battery has various problems such as setting space, a price, and a safe use for an early introduction and spread to consumers. Therefore, the demand for small batteries such as a stationary type battery for home, EV and the built-in battery in the notebook PC is anticipated

In order to reduce the peak electricity by utilizing the battery, a technique to centrally manage plural batteries is proposed. The technique is to create control plan that prescribed the charge and discharge of each battery for every time band and to control each battery according to the control plan of the charge and discharge. However, the battery, of which consumers have, has the original introduction purpose. That is, the original introduction purpose of the battery is that the stationary type battery is for securing of back-up power against a blackout, the EV is fuel for moving, and the notebook PC is a power supply for battery drive at the time of going out. Therefore, it is preferable to create the charge and discharge control plan for reducing peak electricity without conflicting with the original introduction purpose.

For example, as the organization which utilized the battery, a first method, which creates a driving plan of a generator and the battery based on an electricity demand prediction and reduces generation cost of the supply side, is disclosed (for example, following patent documents 1 and 2). In addition, the second method, which repeats the creation of a provisional charge and discharge control plan and evaluation of the provisional charge and discharge control plan based on an electricity demand prediction and creates the charge and discharge control plan which is near ideal in a short time, is disclosed (for example, following paten document 3).
[patent document 1] Japanese Laid-open Patent publication No. 2005-102357.
[patent document 2] Japanese Laid-open Patent publication No. 2008-067469.
[patent document 3] Japanese Laid-open Patent publication No. 2013-132195.

### SUMMARY

However, by the first method, because it is assumed that there is the battery on the supply side, it is not assumed that a consumer has a battery, and the battery is utilized for a purpose except the reduction of the peak electricity. Therefore, there has a possibility to invite the situation not to satisfy an original introduction purpose such that it is not possible to use the electricity because of lack of the residual quantities of the battery at the time of a blackout or to drive battery of the notebook PC because of running out of the battery at going out. In addition, it is difficult to apply a large quantity of batteries because it is not easy to make a plan in consideration of plural batteries.

In addition, by the second method, the charge and discharge control plan is created only based on an electricity demand prediction, the specifications of each battery, current charge and discharge states and current residual quantity. Therefore, it is caused to negatively increase peak electricity or decrease an effect of the reduction of the peak electricity, because the scheduled control is not realized when the notebook PC is driven by the battery at the going out, etc.

According to a first aspect of the embodiment, a device of controlling a charge and discharge of a battery, the device includes a storing device configured to store a plurality of charge and discharge control plans which define the charge and discharge state including a discharge state, an electricity state and a charge state of the battery in each of time bands, and an unplanned use history list including an unplanned use entry which has duration time and the charge and discharge state when the unplanned use occurs, and a control device configured to acquire the charge and discharge state of a first battery, compares acquired charge and discharge state with the charge and discharge state defined in the charge and discharge control plan, detects a first unplanned use when the acquired charge and discharge state is different from the charge and discharge state defined in the charge and discharge control plan, estimates duration time and charge and discharge state of the first unplanned use based on the unplanned entry which is corresponding to the first unplanned use and is stored in the unplanned use history list, corrects the charge and discharge control plan of the first battery so as to have the estimated charge and discharge state in estimated duration time of the first unplanned use, and corrects the charge and discharge control plan of a second battery, which has the estimated charge and discharge state in the estimated duration time, corresponding to correction of the charge and discharge control plan of the first battery.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram indicating an example of the constitution of the charge and discharge control device of the battery according to an embodiment.

FIG. 2 is a diagram indicating the construction of the charge and discharge control device according to the embodiment.

FIG. 3 is a diagram explaining the peak electricity based on the charge and discharge control device 100 of the battery in the embodiment.

FIG. 4 is a diagram indicating an example of the charge and discharge control plan table PL described in FIG. 2.

FIG. 5 is a diagram explaining a flow of the process by the construction of the charge and discharge control device 100 of the battery in FIG. 2 according to the first embodiment.

FIG. 6 is a diagram of a flow chart explaining process of the charge and discharge control device 100 of the battery in FIG. 1 and FIG. 2 according to the first embodiment.

FIG. 7 is a diagram of flow chart explaining process of the charge and discharge control device 100 of the battery according to the first embodiment in greater detail.

FIG. 8A and FIG. 8B are diagrams explaining a specific example of the process by the charge and discharge control device 100 of the battery according to the first embodiment.

FIG. 9 is a diagram of a flow chart explaining the process of the charge and discharge control device 100 of the battery according to the second embodiment.

FIG. 10 is a diagram of a flow chart explaining the processes of the charge and discharge control device 100 of the battery in the second embodiment in detail.

FIG. 11 is a diagram explaining specific examples of the processes of the charge and discharge control device 100 of the battery according to the second embodiment.

FIG. 12 is a diagram of flow chart explaining a flow of the processes of the charge and discharge control device 100 of the battery according to the third embodiment.

FIG. 13 is a diagram of flow chart explaining the processes of the charge and discharge control device 100 of the battery in FIG. 12 in greater detail.

FIG. 14A and FIG. 14B are diagrams explaining specific examples of the processes of the charge and discharge control device 100 of the battery according to the third embodiment.

FIG. 15 is a diagram expressing a process flow of the charge and discharge control device 100 of the battery according to the fourth embodiment.

FIG. 16 is a diagram of a flow chart explaining the processes of the charge and discharge control device 100 of the battery according to the fourth embodiment.

FIG. 17 is a diagram of flow chart explaining the process of the charge and discharge control device 100 of the battery according to the fourth embodiment in FIG. 16.

FIG. 18A, FIG. 18B, FIG. 18C, FIG. 18D, FIG. 18E, and FIG. 18F are diagrams explaining a specific example of the process of the charge and discharge control device 100 of the battery according to the fourth embodiment.

FIG. 19 is a diagram of a flow chart explaining processes of the charge and discharge control device 100 of the battery according to an modification of the fourth embodiment.

FIG. 20 is a diagram expressing a process flow of the charge and discharge control device 100 of the battery according to the fifth embodiment.

FIG. 21 is a diagram of flow chart explaining a flow of the processes of the charge and discharge control device 100 of the battery according to the fifth embodiment.

FIG. 22 is a diagram of a flow chart explaining processes of the charge and discharge control device 100 of the battery according to the fifth embodiment in great detail.

FIG. 23 is a diagram explaining a specific example of the process of the charge and discharge control device 100 of the battery according to the fifth embodiment.

FIG. 24 is a diagram of a flow chart explaining processes of the charge and discharge control device 100 of the battery according to the sixth embodiment.

FIG. 25 is a diagram explaining a specific example of the process of the charge and discharge control device 100 of the battery according to the sixth embodiment.

FIG. 26 is a diagram of a flow chart explaining processes of the charge and discharge control device 100 of the battery according to the seventh embodiment.

FIG. 27 is a diagram explaining a specific example of the process of the charge and discharge control device 100 of the battery according to the seventh embodiment.

### DESCRIPTION OF EMBODIMENTS

(Constitution of Charge and Discharge Control Device of the Battery)

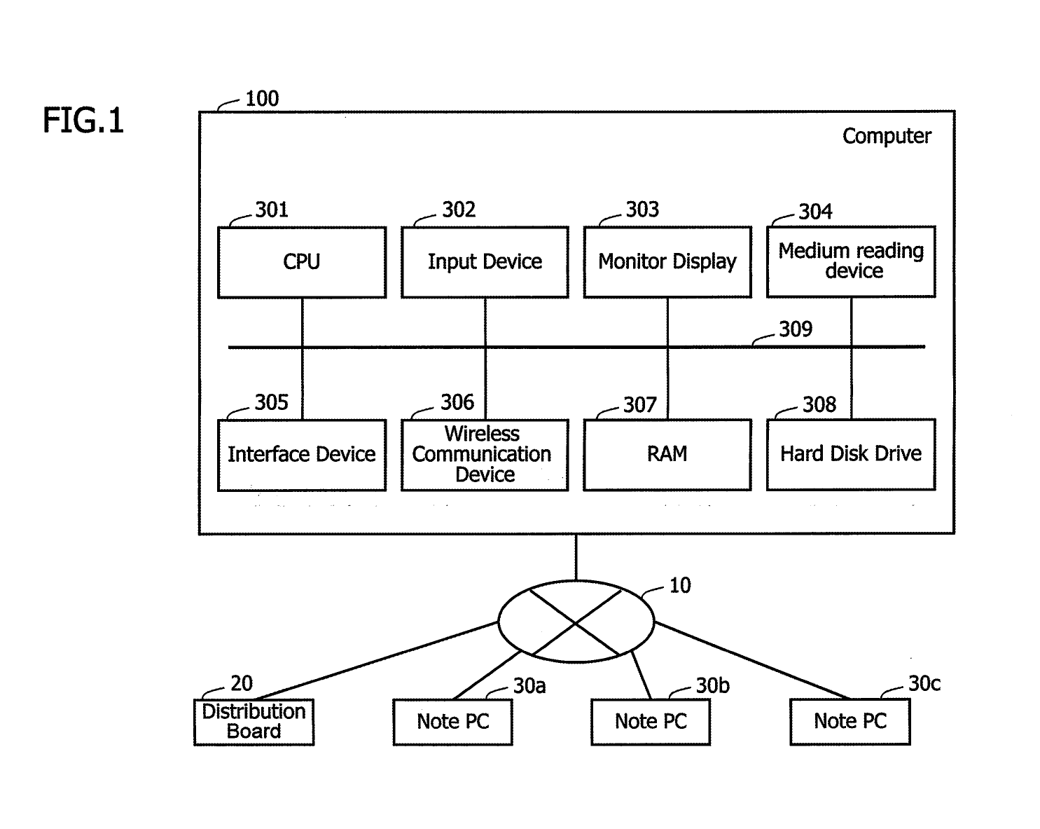

FIG. 1 is a diagram indicating an example of the constitution of the charge and discharge control device of the battery according to an embodiment. As illustrated in FIG. 1, the charge and discharge control device 100 is, for example, a computer, more specially a server device installed in an office. The charge and discharge control device 100 has a CPU (Central Processing Unit) 301, an input device 302 which accepts an input of data from a user, and a monitor display 303. In addition, the charge and discharge control device 100 further has a medium reading device 304 which reads a program, etc. from storage medium, an interface device 305 which connects with other devices and a wireless communication device 306 to connect with other devices by wireless communication. In addition, the charge and discharge control device 100 further has a RAM (Random Access Memory) 307 which temporally stores various data, and a Hard Disk Drive 308. Each device 301-308 is connected through a bus 309.

The Hard Disk Drive 308 stores a program to perform the charge and discharge control process of the battery in the embodiment, for example. In addition, the Hard Disk Drive 308 stores various data to realize the charge and discharge control program of the battery. The CPU 301 reads the program stored in the Hard Disk Drive 308, develops the program into the RAM 307 and realizes the charge and discharge control process of the battery.

In addition, the program to perform the charge and discharge control process of the battery may not be stored in the Hard Disk Drive 308. For example, the CPU 301 may reads a program stored in the recording medium that a computer is readable and may perform the program. For example, the recording medium that a computer is readable correspond to a mobile recording medium such as a CD-ROM (Compact Disk-Read Only Memory), a DVD disk (Digital Versatile Disk), a USB (Universal Serial Bus) memory, and a portable hard disk drive, and a semiconductor memory such as a flash memory. In addition, a device, which is connected to a public line, Internet, LAN (Local Area Network) and WAN (Wide Area Network), stores this program and the CPU 301 may read the program from the device and may perform the program.

As illustrated in FIG. 1, the charge and discharge control device 100 connects with a distribution board 20 and a plurality of notebook PCs (Personal Computer) (described as notebook PC 30 as follows) 30a, 30b and 30c through LAN (Local Area Network) 10 in the company, for example. The notebook PC 30 is the notebook type personal computer which is utilized by a user in the company. In the embodiment, the battery indicates the built-in battery in the notebook PC. The charge and discharge control device 100 according to the embodiment creates the charge and discharge control plan PL which designates the charge and discharge states of the built-in battery in the plurality of notebook PCs for every time band. In addition, for example, an application for clients for controlling the charge and discharge of the built-in battery is installed in the notebook PC 30. The notebook PC 30 changes the charge and discharge states of the built-in battery based on the charge and discharge control plan PL transmitted from the charge and discharge control device 100.

In addition, the LAN 10 in the company, for example, is adopted arbitrary kinds of the communication network such as a cable broadcasting LAN or the wireless LAN and, may be connected to the other networks such as the Internet or the LAN. In addition, for example, the distribution board 20 supplies the electricity to the notebook PC 30a, 30b, 30c through power supply lines (not illustrated in FIG. 1). In addition, in FIG. 1, a case that the charge and discharge control device 100 connects with three notebook PCs 30a, 30b, 30c is exampled, but the embodiment is not limited to this example. That is, the charge and discharge control device 100 may connect with any number of the notebook PC.

(Construction of the Charge and Discharge Control Device)

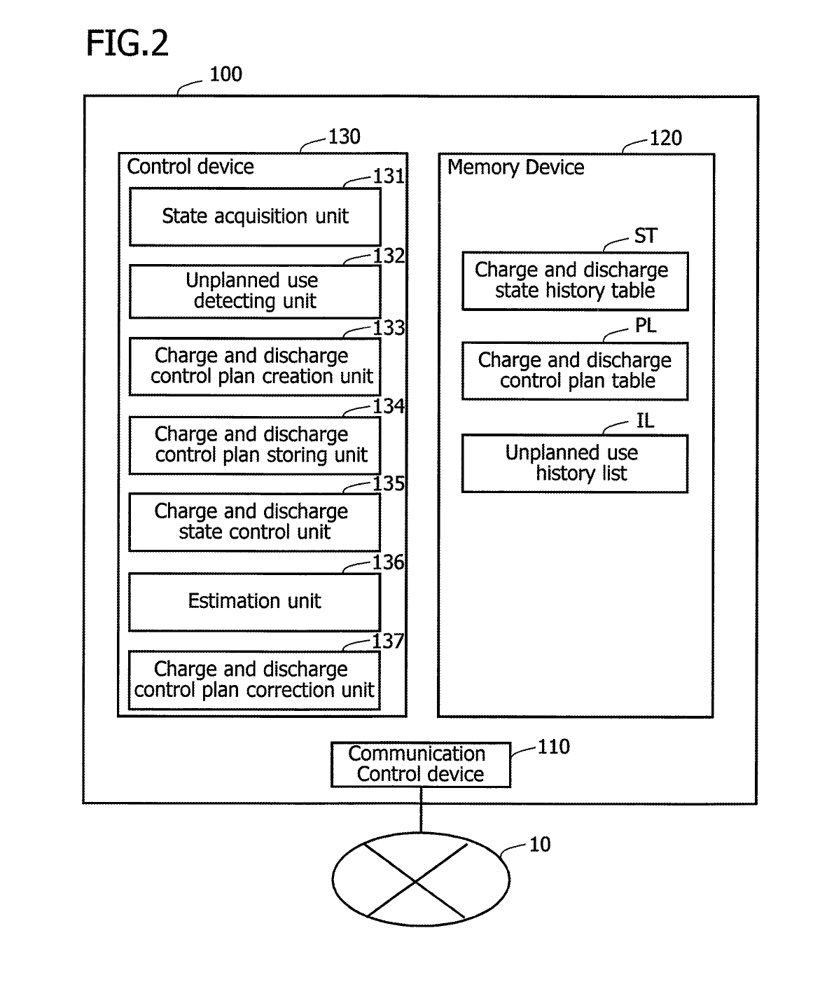

FIG. 2 is a diagram indicating the construction of the charge and discharge control device according to the embodiment. The charge and discharge control device 100 has a communication control device 110, a memory device 120, and a control device 130. The communication control device 110 controls communication about various information transmitted and received to and from the distribution board 20 and the notebook PC 30, as illustrated in FIG. 1. The communication control device 110 corresponds to the wireless communication device 306 and the interface device 305 such as a Network Interface Card (NIC: Network Interface Card), as illustrated in FIG. 1.

The control device 130 has a state acquisition unit 131, an unplanned use detecting unit 132, an estimation unit 136, a charge and discharge control plan correction unit 137, a charge and discharge control plan creation unit 133, a charge and discharge control plan storing unit 134, a charge and discharge states control unit 135. When the control unit 130 is constructed by the CPU 301 in FIG. 1, the CPU 301 executes programs having functions of these units 131, 132, 136, 137, 133, 134 and 135 to perform the charge and discharge control process of the battery. In addition, the control unit 130 may be realized by integrated circuits such as ASIC (Application Specific Integrated Circuit) or FPGA (Field Programmable Gate Array).

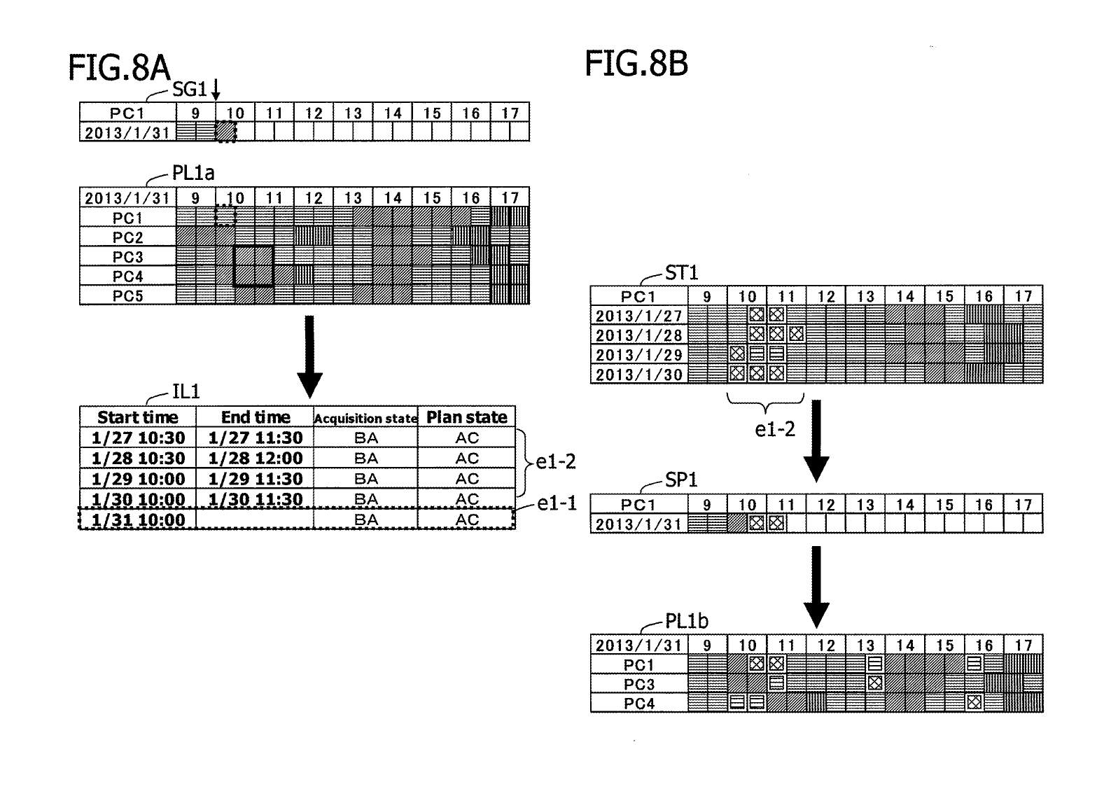

In addition, the memory device 120 stores the charge and discharge state history table ST, the charge and discharge control plan table (below, also called as charge and discharge control plan) PL, and the unplanned use history list IL, as described later by FIG. 8. The control unit 130 creates the charge and discharge state history table ST, the charge and discharge control plan data PL, and the unplanned use history list IL. The memory device 120 corresponds to the RAM 307 and the Hard Disk Drive 308 in FIG. 1. In addition, the memory device 120 may be a storage device such as a semiconductor memory element such as a flash memory, or an optical disk device.

The state acquisition unit 131 in the control unit 130 acquires information such as the charge and discharge states and the residual quantity of the battery from the notebook PC 30 through the LAN 10 and creates the charge and discharge state history table ST. The unplanned use detecting unit 132 compares the acquired charge and discharge states with a charge and discharge states in the charge and discharge control plan table PL and detects the unplanned use state of the battery in the notebook PC 30. In addition, the estimation unit 136 extracts the unplanned use entry in which mode of the unplanned use states is same or similar as or to the detected unplanned use states from the unplanned use history list IL and estimates a duration time and charge and discharge states of the detected unplanned use based on the extracted unplanned use entry.

In addition, the charge and discharge control plan correction unit (called as correction unit as below) 137 corrects the charge and discharge control plan PL of the notebook PC 30 which is detected the unplanned use states by the estimated unplanned use duration time and the estimated charge and discharge states. Further, the correction unit 137 corrects the charge and discharge control plan PL of one or more notebook PCs 30 other than the notebook PC 30 which is detected unplanned use states so that the total of the consumption electricity meets an appointed condition. In other words, the correction unit 137 re-creates (corrects) the charge and discharge control plan PL of two or more notebook PCs 30 including the notebook PC 30 which is detected unplanned use states among all notebook PC 30. The charge and discharge control plan storing unit (below, called as plan storing unit) 134 stores the charge and discharge control plan PL created again in the memory device 120. In addition, the charge and discharge states control unit (below, called as states control unit) 135 controls the charge and discharge of the built-in battery in each notebook PC 30 based on the charge and discharge control plan PL.

(Charge and Discharge State of the Battery)

Here, a state about the charge and discharge of the battery will be explained. In the embodiment, the built-in battery in the notebook PC 30 is exemplified as the battery. In the example, a state of the charge and discharge of the battery includes an electric discharge state BA, an electricity state AC, and a charge state CH.

The electric discharge state BA indicates a state for discharging the built-in battery in the notebook PC and driving the notebook PC by a battery drive. In the electric discharge state BA, the consumption electricity from the AC (Alternating Current) power supply does not occur, but the battery residual quantity decreases with progress of the time. In addition, the electricity state AC indicates a state that none of charging and discharging performs the built-in battery and drives the notebook PC by an AC power. In the electricity state AC, the battery residual quantity does not change even if time passage. In addition, the charge state CH indicates a state which charges the built-in battery and drives the notebook PC by the AC power. In the charge state CH, the consumption electricity from the AC power is larger than the electricity state AC as much as charged quantity. In addition, in the charge state CH, the battery residual quantity increases with progress of the time.

In this way, in the embodiment, the electric discharge state BA, the electricity state AC, and the charge state CH are included in the charge and discharge state. The charge and discharge control device 100 of the battery creates the charge and discharge control plan PL and controls the batteries based on the charge and discharge control plan PL. Thereby, the peak electricity is controlled.

(Reduction of the Peak Electricity)

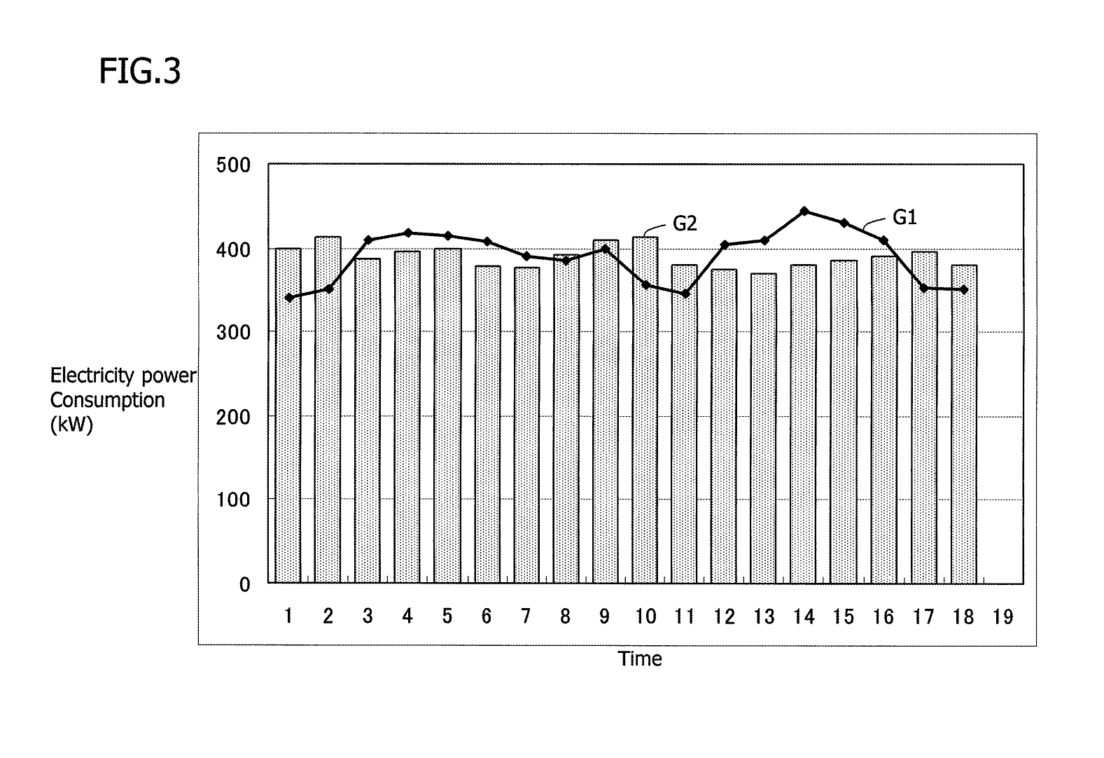

FIG. 3 is a diagram explaining the peak electricity based on the charge and discharge control device 100 of the battery in the embodiment. In FIG. 3, the horizontal axis indicates each time (T) in one day, and the vertical axis indicates power consumption (kW: Kilo-Watt). In addition, in FIG. 3, a bar graph G2 indicates a transition of the power consumption when controlled the battery based on the charge and discharge control plan PL, and line graph G1 indicates a transition of the power consumption when did not controlled the battery based on the charge and discharge control plan PL. In the example, the power consumption is a grand total of the power consumptions in appointed ranges such as the office, the building such as companies or the area. The power consumption includes the consumption electricity with the apparatus except the battery in addition to the battery.

The value of the consumption electricity in the embodiment indicates the total value of the electricity to consume in the electricity state AC and the charge state CH of the control target notebook PC and the electricity of other device except the control target notebook PC. Or, a value of the consumption electricity is the electricity level that measured electricity to be supplied from the distribution board 20 (referring to FIG. 1). And the peak electricity is the biggest consumption electricity among the consumption electricity for every unit hour. In addition, the time when the consumption electricity becomes biggest is a peak time.

In FIG. 3, the line graph G1, which is not based on the charge and discharge control plan PL, represents that the transition of the electricity is not stable and the peak electricity becomes high. On the other hand, the bar graph G2, which is based on the charge and discharge control plan PL, represents that the transition of the electricity is stable and that the planned reduction of peak electricity is enabled. The charge and discharge control device 100 controls the charge and discharge states of the battery based on the charge and discharge control plan PL and increases and decreases the consumption electricity of the battery. Thereby, the variation of supplied electricity power at each time is suppressed while reducing the peak electricity. Accordingly, therefore, it is possible to reduce peak electricity including the consumption electricity of the device except the battery, because the charge and discharge control device 100 regulates the consumption electricity by controlling based on the charge and discharge control plan PL. In addition, for example, because the tendency of the transition of the consumption electricity varies according to a day and a season, the charge and discharge control device 100 of the battery may create a plural pattern of the charge and discharge control plan PL in response to a day and a season.

(Charge and Discharge Control Plan PL)

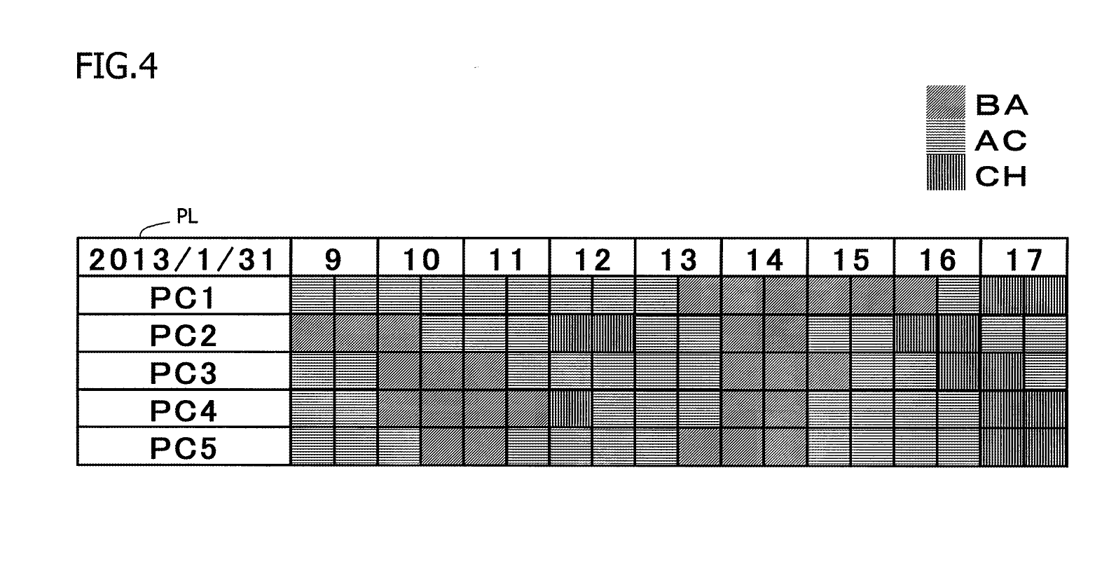

FIG. 4 is a diagram indicating an example of the charge and discharge control plan table PL described in FIG. 2. The charge and discharge control plan PL in FIG. 4 is the charge and discharge control plan PL of the notebook PC1-PC5 in 2013 year, January 31 (2013/01/31). In the charge and discharge control plan PL in FIG. 4, the charge and discharge states is defined to a unit for 30 minutes, for example. However, the charge and discharge states is not limited to the example, and the charge and discharge states may be defined to a unit for one hour.

In FIG. 4, a block marked by rising diagonal stroke from top right to bottom indicates the discharge state BA, a block marked by horizontal stroke from right to left indicates the electricity state AC, and a block marked by vertical stroke from top to bottom indicates the charge state CH. As illustrated in FIG. 4, in the charge and discharge control plan (table) PL, the states of the notebook PC1 is defined to the electricity state AC from 09:00 to 13:30 and from 16:30 to 17:00, the discharge state BA from 13:30 to 16:30 and the charge state CH from 17:00 to 18:00. As illustrated in FIG. 4, in the charge and discharge control plan (table) PL, the states of the notebook PC2 is defined to the electricity state AC from 10:30 to 12:00, from 13:00 to 14:00, from 15:00 to 16:00 and from 17:00 to 18:00, the discharge state BA from 9:00 to 10:30 and from 14:00 to 15:00 and the charge state CH from 12:00 to 13:00 and from 16:00 to 17:00. In addition, as same as, about the other notebook PC3-PC5, the charge and discharge states is appointed for every unit hour.

By the way, the state control unit 135 cannot control the charge and discharge of each notebook PC 30 according to designation of the charge and discharge control plan PL. For example, when the need of the battery drive occurs in the notebook PC by a business trip or a meeting even if the electricity state AC or the charge state CH is appointed to the notebook PC by the charge and discharge control plan PL, the notebook PC 30 becomes the electric discharge state BA. A case to unable to control the charge and discharge states of the notebook PC 30 according to the designation of the charge and discharge control plan PL is called as unplanned use, as follows. When the unplanned use state occurs, it is difficult to control the consumption electricity as scheduled.

### First Embodiment

Therefore, the charge and discharge control device 100 of the battery according to the embodiment acquires the charge and discharge state including the discharge state BA, the electricity state AC, and the charge state CH of the notebook PC 30, and detects a first unplanned use state when the acquired charge and discharge state is different from the charge and discharge state appointed in the charge and discharge control plan PL. And the charge and discharge control device 100 of the battery estimates the duration time and the charge and discharge state of the first unplanned use based on unplanned use entry which is corresponding to the first unplanned use and is stored in the unplanned use history list IL of the first notebook PC 30 which is detected the first unplanned use. And the charge and discharge control device 100 of the battery corrects the charge and discharge control plan PL of the first notebook PC 30 so as to have the estimated charge and discharge state in the estimated duration time of first unplanned use. Further, device 100 corrects the charge and discharge control plan PL of the second notebook PC 30 which designated the estimated charge and discharge state in the estimated duration time of the charge and discharge control plan PL, corresponding to the correction of the charge and discharge control plan PL of the first notebook PC 30.

It is possible that the charge and discharge control device 100 of the battery estimates the duration time and the charge and discharge state of the unplanned use (the first unplanned use) which is detected by using the unplanned use history list IL. And the charge and discharge control device 100 of the battery corrects the charge and discharge state in the estimated duration time of the charge and discharge control plan PL of the notebook PC (the first notebook PC 30) which is detected the unplanned use by the estimated charge and discharge state. Further, device 100 corrects the charge and discharge control plan PL of another (second) notebook PC 30 so as to cancel the increase or decrease of the consumption electricity by the unplanned use. It is quickly avoided the increase of the peak electricity by the unplanned use by correcting the charge and discharge control plan PL of some notebook PCs including the notebook PC 30 which is detected the unplanned use. Accordingly, it is possible to suppress the peak electricity surely even if the notebook PC 30 is not controlled according to designation of the charge and discharge control plan PL.

Next, the process of the charge and discharge control device 100 of the battery according to the first embodiment will be explained.

(Summary of the Process)

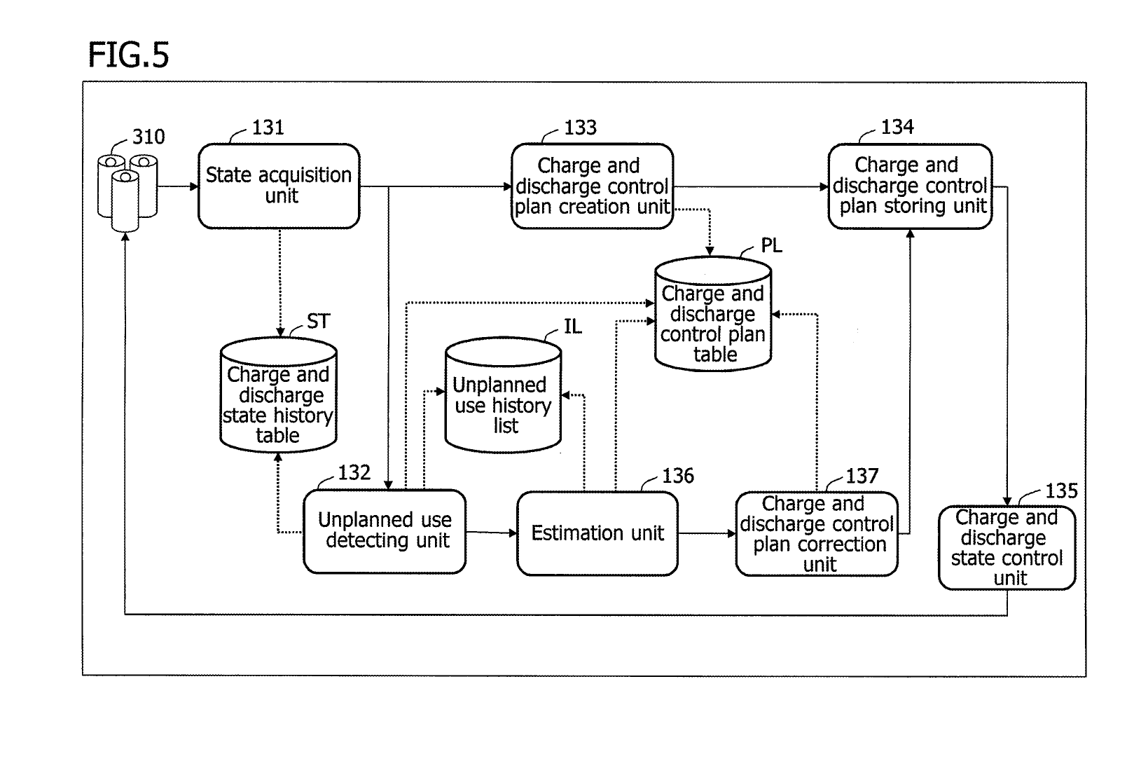

FIG. 5 is a diagram explaining a flow of the process by the construction of the charge and discharge control device 100 of the battery in FIG. 2 according to the first embodiment. In FIG. 5, same elements as depicted by FIG. 2 are marked same symbols. The state acquisition unit 131 acquires current charge and discharge state and a residual quantity of the battery 310 in each notebook PC 30 and stores the charge and discharge state of each notebook PC 30 in the charge and discharge state history table ST in the memory device 120. The charge and discharge control plan creation unit (below, called as plan creation unit) 133 periodically creates the charge and discharge control plan PL having either one of the charge and discharge state in which the peak electricity becomes small based on the battery residual quantities of each notebook PC 30. The plan storing unit 134 stores the created charge and discharge control plan PL into database (memory device 120). The state control unit 135 controls the battery 310 of each notebook PC based on the charge and discharge control plan PL created periodically.

In addition, the unplanned use detecting unit 132 detects the unplanned use state when the acquired charge and discharge state is different from the charge and discharge state designated by the charge and discharge control plan PL. The unplanned use detecting unit 132 creates the unplanned use history list IL based on information of the unplanned use which is detected. In addition, the estimation unit 136 estimates the duration time for the unplanned use which is detected and the charge and discharge state in the duration time with reference to unplanned use history list IL and the charge and discharge state history table ST. The plan correction unit 137 corrects the charge and discharge state in the estimated duration time of the charge and discharge control plan PL of the notebook PC which is detected the unplanned use by the estimated charge and discharge state. Further, plan correction unit 137 corrects the charge and discharge control plan PL of some notebook PCs 30 so as to cancel the increase of the consumption electricity by the unplanned use. Therefore, the plan correction unit 137 creates the charge and discharge control plan PL of some notebook PCs 30 again whereas the plan creation unit 133 creates the charge and discharge control plan PL of all notebooks PC 30.

(Process Flow)

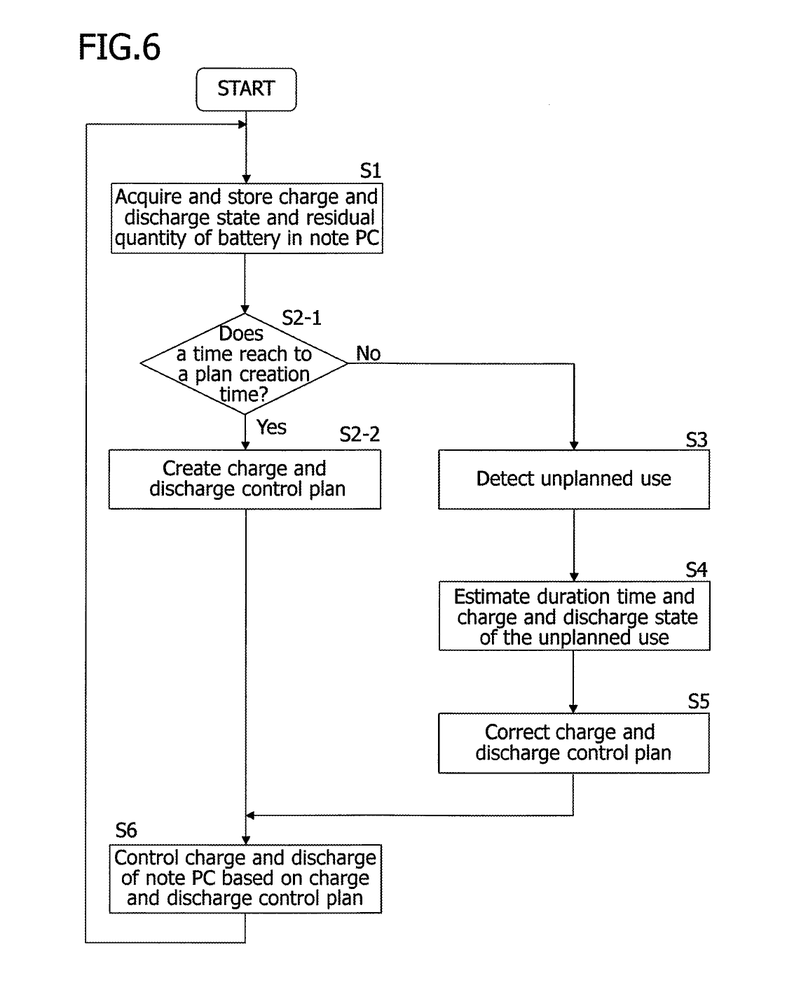

FIG. 6 is a diagram of a flow chart explaining process of the charge and discharge control device 100 of the battery in FIG. 1 and FIG. 2 according to the first embodiment. At first the state acquisition unit 131 acquires the charge and discharge state and a residual quantity of the battery in each of notebook PCs 30 and saves the acquired state and residual quantity (S1). For example, the state acquisition unit 131 acquires periodically the charge and discharge state and a battery residual quantity of each notebook PC 30 (for example, every 30 minutes).

For example, the state acquisition unit 131 acquires the charge and discharge state of the built-in battery in the notebook PC 30 using OS (Operation System) command and API (Application Programming Interface) of the battery driver. Or, the state acquisition unit 131 acquires a battery residual quantity of the notebook PC 30, and may judge the charge and discharge state based on the change of the battery residual quantity. When based on the change of the battery residual quantity, the unit 131 may judge that the state is the discharge state BA when the battery residual quantity decreases, is the electricity state AC when the battery residual quantity is constant, and is the charge state CH when the battery residual quantity increases. Or, an outside measuring device measures the consumption electricity of the notebook PC 30 and the state acquisition unit 131 may judge the charge and discharge state of the notebook PC 30 based on the measured electricity level of the measuring device. When based on the measured electricity level, the unit 131 may judge that the state is the discharge state BA when the measured level is “0”, is the electricity state AC when the measured level is lower than a standard value, and is the charge state CH when the measured level is higher than the standard value.

In addition, the charge and discharge control device 100 of the battery may periodically require the charge and discharge state to the notebook PC 30 and may receive the charge and discharge state as a reply from the notebook PC 30. Or the notebook PC 30 may periodically notify the charge and discharge state to the charge and discharge control device 100 of the battery. Or an outside measuring device may perform a transmission and a notice of the charge and discharge state to the charge and discharge control device 100 in substitution for the notebook PC 30.

Then, the plan creation unit 133 determines whether a time reaches the creation time of the charge and discharge control plan PL (S2-1). The plan creation unit 133 creates the charge and discharge control plan PL of the day every morning at 7:00, for example. The plan creation unit 133, when the time reaches at the creation time, creates the charge and discharge control plan PL so that the peak electricity becomes small by referring to a predict electricity demand, specifications of each notebook PC 30, and the current charge and discharge state and battery residual quantity of the battery in the notebook PC 30 (S2-2). For example, a known creation method of the charge and discharge control plan PL which lowers the peak electricity is adopted as follows.

For example, the plan creation unit 133 makes a provisional charge and discharge control plan PL. And the plan creation unit 133 simulates the consumption electricity for every time using the provisional charge and discharge control plan PL. The plan creation unit 133, when the peak electricity decreases than that of last regular charge and discharge control plan PL, determines the provisional charge and discharge control plan PL as a regular charge and discharge control plan PL. And the plan creation unit 133 repeats the creation process and an evaluation by simulation of the provisional charge and discharge control plan PL until scheduled time passes and determines the charge and discharge control plan PL that the peak electricity is smaller. Thereby, the plan creation unit 133 creates the charge and discharge control plan PL having either one the charge and discharge and where the peak electricity becomes small.

And the state control unit 135 controls the battery of each notebook PC based on the charge and discharge control plan PL which is created via the LAN 10. Or the state control unit 135 may transmit the charge and discharge control plan PL to each of notebook PCs 30, and each notebook PC may control the built-in battery based on transmitted charge and discharge control plan PL.

On the other hand, the unplanned use detecting unit 132, when the time does not reach the creation time of the charge and discharge control plan PL (NO/S2-1), compares the current charge and discharge state which is acquired with the charge and discharge state, which is appointed at the current time, in the charge and discharge control plan PL and detects the unplanned use when both charge and discharge states are different each other (S3). The estimation unit 136, when detecting the unplanned use, refers to the charge and discharge state history table ST based on the unplanned use history list IL of the notebook PC 30 which is detected the unplanned use and estimates the duration time of the unplanned use and the charge and discharge state in the duration time (S4). Then, the plan correction unit 137 corrects the charge and discharge state in the estimated duration time into the estimated charge and discharge state in the charge and discharge control plan PL of the notebook PC 30 where the unplanned use is detected and corrects the charge and discharge state of the charge and discharge control plan PL of different notebook PC 30 so as to cancel the increase and decrease of the consumption electricity by the correction of the charge and discharge control plan PL of the notebook PC 30 where the unplanned use is detected (S5). And the state control unit 135 controls the battery of each notebook PC based on the charge and discharge control plan PL which is corrected via the LAN 10 (S6).

In addition, in FIG. 6, the unplanned use detecting unit 132 processes the detection for unplanned use (S3) after the state acquisition unit 131 acquires the charge and discharge state of the built-in battery in the notebook PC 30 (S1). However, the unplanned use unit 132 may periodically process the detection without depending on the timing of the acquisition process of the state acquisition unit 131. In addition, the unplanned use detecting unit 132 detects the unplanned use where the current charge and discharge state is different from the charge and discharge appointed at the current time in the charge and discharge control plan PL (S3). However, the unplanned use detecting unit 132 may detect as the unplanned use when the state acquisition unit 131 does not acquire the charge and discharge state (for example, the notebook PC is disconnected from the network or is not worked) or when the acquired residual quantity of the battery has a large difference from the battery residual quantity that is predicted when controlling the battery of the notebook PC 30 based on the charge and discharge control plan PL. Furthermore, the unplanned use detecting unit 132 may detect as the unplanned use when duration time of the unplanned use is more than a predetermined time for the purpose of excluding temporary unplanned use (movement of the position or reboot).

The details of each process in the steps S3-S5 in FIG. 6 will be explained.

(Detail Process in Steps S3-S5)

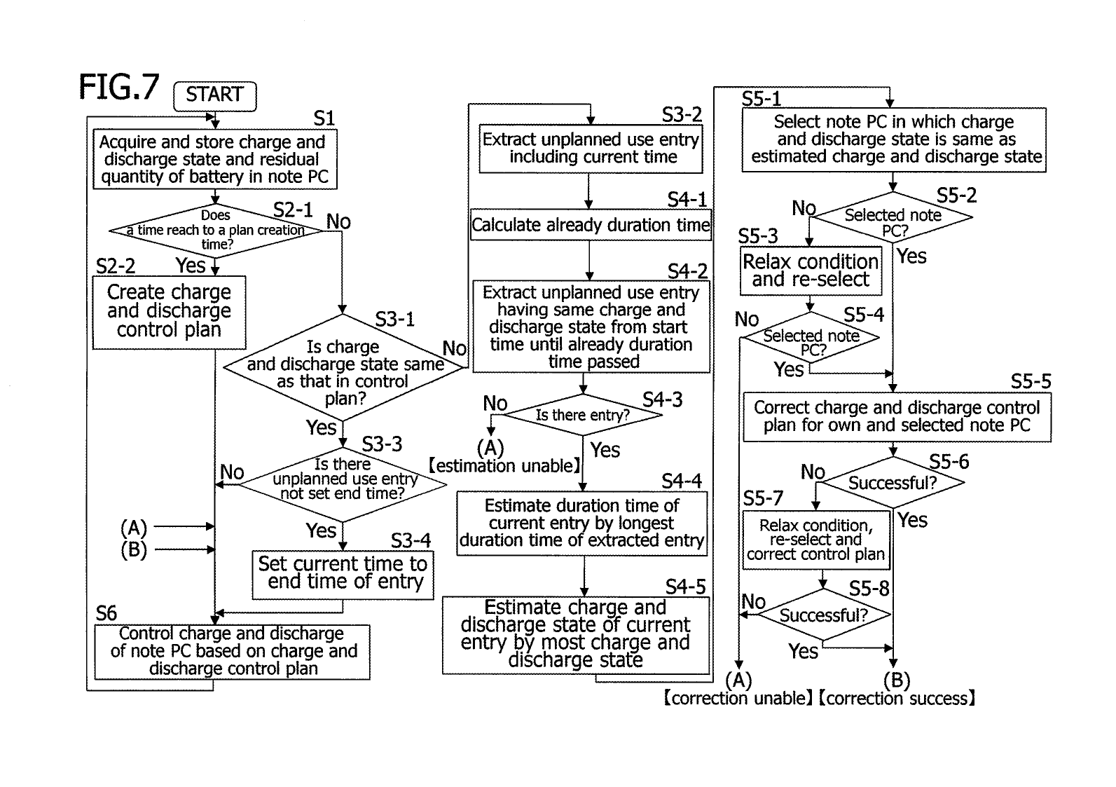

FIG. 7 is a diagram of flow chart explaining process of the charge and discharge control device 100 of the battery according to the first embodiment in greater detail. In FIG. 7, same processes as the process in FIG. 6 are indicated by same symbol. Therefore, the processes in the steps S1, S2-1, S2-2 and S6 are same as described in FIG. 6 and are omitted for the explanation. Firstly, the details of the processes in the step S3 will be explained. When it does not reach at the creation time of the charge and discharge control plan PL (S2-1/NO), the unplanned use detecting unit 132 compares the acquired current charge and discharge state with the charge and discharge state appointed at the current time in the charge and discharge control plan PL (S3-1). The unplanned use detecting unit 132 detects the unplanned use when the charge and discharge state is different from each other (No/S3-1), because the notebook PC 30 is not controlled according a designation in the charge and discharge control plan PL.

The unplanned use detecting unit 132 extracts unplanned use entry including the current time between a start time and an end time from the unplanned use history list IL of the notebook PC 30 which is detected the unplanned use (S3-2), when the unplanned use detecting unit 132 detects the unplanned use (No/S3-1). Or, the unplanned use detecting unit 132 extracts the unplanned use entry, of which the end time is not set yet, from the unplanned use history list IL (S3-2). When there is not the unplanned use entry which is extracted, the unplanned use detecting unit 132 creates new unplanned use entry because the unplanned use newly occurs (S3-2). The unplanned use entry which is extracted out or the unplanned use entry which is newly created indicates the unplanned use entry corresponding to the unplanned use currently in progress detected in the step S3-1.

For example, the unplanned use entry has the start time and the end time of the unplanned use, the charge and discharge state (below, called as acquisition state) which is acquired at the start of the unplanned use, the charge and discharge state (below, called as plan state) which is appointed by the charge and discharge control plan PL at the start time of the detection. When the unplanned use detecting unit 132 creates the unplanned use entry newly, in the new unplanned use entry, the start time is set as the current time, the end time is set as a blank, the acquisition state is set as the current charge and discharge state, and the plan state is set as the charge and discharge state which is appointed by the charge and discharge control plan PL at the current time.

On the other hand, when the unplanned use detecting unit 132 does not detect the unplanned use, that is, the acquisition state is same as the plan state (YES/S3-1), the unplanned use detecting unit 132 determines whether or not there is the unplanned use entry which is not set the end time (S3-3) and sets the current time in the end time (S3-4) when there is the unplanned use entry which is not set the end time (YES/S3-3). In other words, a case, that there is the unplanned use entry which is not set the end time when not detecting the unplanned use, indicates the end of the unplanned use currently in progress. Therefore, the unplanned use detecting unit 132, when there is the unplanned use entry which is not set the end time (YES/S3-3), updates the unplanned use entry into the end state. When there is not the unplanned use entry which is not set the end time (NO/S3-3), the unplanned use detecting unit 132 does not execute the process in the step S3-4.

When the unplanned use detecting unit 132 detects the unplanned use (No/S3-1), the estimation unit 136 calculates the duration time that already passed for the unplanned use (S4-1) following the extraction process of the unplanned use entry (S3-2). Specially, the estimation unit 136 calculates time from the start time to the current time of the unplanned use entry currently in progress as the duration time (below, called as already duration time) that already passed. In addition, the already duration time of the unplanned use entry which is created newly is 0 hours.

The estimation unit 136 extracts the unplanned use entry which has same charge and discharge state as the unplanned use currently in progress now from the unplanned use history list IL of the notebook PC 30 which is detected the unplanned use (S4-2). For example, the estimation unit 136 extracts the unplanned use entry which has same acquisition state, same plan state and same charge and discharge state until the already duration time is passed as the unplanned use currently in progress from the unplanned use history list IL of the notebook PC 30 which is detected the unplanned use. In this time, the estimation unit 136 acquires the charge and discharge state until the already duration time is passed, which corresponds to the unplanned use history list IL from the charge and discharge state history table ST. In addition, the already duration time of the unplanned use entry which is created newly is 0 hours. When the already duration time of the unplanned use entry which is created newly is 0 hours, the estimation unit 136 extracts the unplanned use entry which has same acquisition state and same plan state as the unplanned use currently in progress from the unplanned use history list IL of the notebook PC 30 which is detected. Thereby, it is possible that the estimation unit 136 extracts one or more unplanned use entries which have same states as the detected unplanned use from the unplanned use history list IL of the notebook PC 30.

When there is not the unplanned use entry which is extracted (NO/S4-3), the estimation unit 136 determines that it not to be able to estimate the duration time and the charge and discharge state of the unplanned use currently in progress and does not correct the charge and discharge control plan PL (indicated by “(A)” in FIG. 7), thereby the process goes to the step S6. On the other hand, when there is the unplanned use entry which is extracted (YES/S4-3), the estimation unit 136 estimates the duration time and the charge and discharge state of the unplanned use currently in progress based on the unplanned use entry which is extracted. As described above, the extracted unplanned use entry is an unplanned use entry which has same state as the unplanned use currently in progress.

Then, the estimation unit 136 estimates the duration time of the current unplanned use by assuming when the unplanned use continues for longest time based on the unplanned use entry which is extracted (S4-4), for example. Specially, the estimation unit 136 estimates the longest duration time among the duration times of the unplanned use entries which are extracted as the duration time of the current unplanned use. It is possible that the realization of the charge and discharge control plan PL becomes high because the estimation unit 136 estimates the duration time of the current unplanned use by assuming when the unplanned use continues for longest time. In addition, the estimation unit 136 may estimate the average of the duration time of the unplanned use entries which are extracted as the duration time of the unplanned use currently in progress. After the estimation unit 136 estimates the duration time, the estimation unit 136 sets the time which is added the start time with the estimated duration time into the end time of the unplanned use entry currently in progress. In addition, estimated unit 136 updates the end time when the end time of the unplanned use entry currently in progress has been already set.

Then, the estimation unit 136 acquires each of the charge and discharge state from already duration time passed until the end time of the unplanned use entries which are extracted. And the estimation unit 136 estimates the most charge and discharge state among the charge and discharge states which is passed predetermined time from the start time in the extracted unplanned use entries which are extracted as the charge and discharge state which is passed predetermined time from the start time, for every unit time (S4-5). It is possible that the realization of the charge and discharge control plan PL becomes high because the estimation unit 136 estimates the charge and discharge state of the current unplanned use from the charge and discharge state of the unplanned use which has same state.

Then, the plan correction unit corrects the charge and discharge control plan PL of some notebook PCs 30 including the notebook PC 30 which is detected the unplanned use based on information (the duration time and the charge and discharge state) of the unplanned use which is estimated. Specially, the plan correction unit 137, at first, selects one or more other notebook PC 30 having same charge and discharge state in the charge and discharge control plan PL as the estimated charge and discharge state until the end time of the unplanned use currently in progress, as target notebook PC 30 for cancelling influence of the unplanned use currently in progress (S5-1). However, the plan correction unit 137 excludes the notebook PC 30 where is detected the unplanned use and is corrected the charge and discharge control plan PL from a selection of the notebook PC 30 for cancelling the influence.

When the target notebook PC 30 for cancelling the influence is not found (NO/S5-2), the plan correction unit 137 selects the notebook PC 30 by relieving a condition (S5-3). For example, the plan correction unit 137 selects one or more notebook PCs 30 having the charge and discharge state where is the same as the charge and discharge state which is estimated in the charge and discharge control plan PL, in every unit hour until the end time of the unplanned use currently in progress (S5-3). Or, for example, the plan correction unit 137 may select the notebook PC 30 where is detected the unplanned use and is corrected the charge and discharge control plan PL as the target notebook PC 30 for cancelling the influence if the duration time does not overlap the unplanned use currently in progress. When the notebook PC 30 is not found even if relaxing the condition (NO/S5-4), the plan correction unit 137 does not correct the charge and discharge control plan PL (indicated by “(A)” in FIG. 7), thereby the process goes to the step S6.

When the selected notebook PC 30 is found (YES/S5-2 and YES/S5-4), the plan correction unit 137 re-creates (corrects) the charge and discharge control plan PL after the current time of the notebook PC 30 which is detected the unplanned use currently in progress and selected one or more notebook PCs 30 (S5-5). The plan correction unit 137 according to the embodiment re-creates (corrects) the charge and discharge control plan PL of only some notebook PCs 30 including the notebook PC 30 which is detected the unplanned use. Thereby, it is possible to correct the charge and discharge control plan PL in response to the detection for the unplanned use more quickly.

Specially, the plan correction unit 137 corrects the charge and discharge state in the estimated duration time of the charge and discharge control plan PL of the notebook PC which is detected the unplanned use currently in progress so as to have the estimated charge and discharge state in the estimated duration time of the unplanned use. Further, the plan correction unit 137 corrects the charge and discharge control plan PL of selected notebook PC 30 in response to the correction of the charge and discharge control plan PL of the notebook PC which is detected the unplanned use currently in progress. More specially, the plan correction unit 137 corrects the charge and discharge control plan PL of selected notebook PC 30 so as to cancel the increase of the consumption electricity by the unplanned use. For example, the plan correction unit 137 corrects the charge and discharge state in the estimated duration time of the charge and discharge control plan PL of selected notebook PC 30 into the charge and discharge state of the charge and discharge control plan PL of the notebook PC 30 which is detected the unplanned use before the correction. In other words, the plan correction unit 137 corrects the charge and discharge control plan PL of the selected notebook PC 30, into the opposite direction of the charge and discharge control plan PL of the notebook PC 30 which is detected the unplanned use.

In addition, the plan correction unit 137 may correct the charge and discharge control plan PL so that the peak electricity based on the charge and discharge control plan PL after the correction of the selected notebook PC 30 does not exceed the peak electricity based on the charge and discharge control plan PL before the correction, or may correct the charge and discharge control plan PL so that the peak electricity do not exceed an appointed limit level. Thereby, it is possible to reduce the correction range in the charge and discharge control plan PL, because the plan correction unit 137 corrects the charge and discharge control plan PL more flexibly. In addition, it is possible to the plan correction unit 137 reduces the number of target notebook PC 30 for cancelling the influence.

Furthermore, the plan correction unit 137 corrects the charge and discharge state in the time except the estimated duration time in the charge and discharge control plan PL of the notebook PC which is detected the unplanned use so as to control the charge and discharge state which is estimated in the duration time. For example, when the plan correction unit 137 corrects the charge and discharge state in the duration time of the charge and discharge control plan PL of the notebook PC which is detected the unplanned use, from the electricity state AC to the discharge state BA, the plan correction unit 137 corrects the charge and discharge state in the time designated by the discharge state BA except the duration time, to the electricity state AC. In other words, the plan correction unit 137 corrects the charge and discharge state of the charge and discharge control plan PL, including the time except the estimated duration time, of the notebook PC which is detected the unplanned use, so that a battery residual quantity of notebook PC 30 is not short. Thereby, it is possible to suppress the peak electricity more surely and to raise the realization of the charge and discharge control plan PL.

In addition, when the creation of the charge and discharge control plan PL is failed (NO/S5-6), the plan correction unit 137 relaxes a condition and corrects charge and discharge control plan PL (S5-7). For example, the plan correction unit 137 increases the number of target notebook PCs 30 for cancelling the influence. And the plan correction unit 137 corrects the charge and discharge control plan PL of the notebook PC which is detected the unplanned use and the target notebook PC 30 which are increased. When the creation of the charge and discharge control plan PL is failed even though increasing the number of the notebook PC 30 (NO/S5-8), the plan correction unit 137 does not correct the charge and discharge control plan PL (indicated by “(A)” in FIG. 7), thereby the process goes to the step S6. On the other hand, when the creation of the charge and discharge control plan PL is successful (YES/S5-6), the plan correction unit 137 updates the charge and discharge control plan PL by the charge and discharge control plan PL after the correction (indicated by “(B)” in FIG. 7), thereby the process goes to the step S6.

And when the process goes to (A) and (B) in FIG. 7, the state control unit 135 controls a battery of each notebook PC 30 based on the charge and discharge control plan PL after the correction (S6). In addition, when the correction of the charge and discharge control plan PL is not performed, the state control unit 135 controls a battery of each notebook PC 30 based on the original the charge and discharge control plan PL where a correction is not carried out.

In addition, the plan correction unit 137 may establish the upper limit and the lower limit for the number of target notebook PC 30 for cancelling the influence of the unplanned use. For example, when the number of selected notebook PC exceeds the upper limit which is established, the plan correction unit 137 selects the upper limit number of the notebook PC 30. The upper limit is set to the number of notebook PCs 30 and a range of the charge and discharge control plan PL which is corrected becomes narrow. It is possible that the plan correction unit 137 suppresses a load to re-creating process and quickly creates the charge and discharge control plan PL.

On the other hand, when the number of selected notebook PC is fewer than the lower limit which is established, the plan correction unit 137 relaxes a condition and adds the notebook PC 30 to be selected, for example. The lower limit is set to the number of selected notebook PC 30 and the target notebook PC for cancelling the influence of the unplanned use is secured. It is possible that the plan correction unit 137 raises the success rate of the correction process of the charge and discharge control plan PL.

Next, the process of the charge and discharge control device 100 of the battery illustrated in FIG. 6 and FIG. 7 according to the first embodiment will be explained based on a specific example.

(Specific Example)

FIG. 8A and FIG. 8B are diagrams explaining a specific example of the process by the charge and discharge control device 100 of the battery according to the first embodiment. FIG. 8A indicates the charge and discharge state SG1 of the PC1 which is acquired, the charge and discharge control plan (table) PL1a before the correction, the unplanned use history list Ill of the PC1. And FIG. 8B indicates the charge and discharge state history table ST1 of the PC1, the estimated information SP1 and the charge and discharge control plan PL1b after the correction. In FIG. 8A and FIG. 8B, same portions as FIG. 4 are illustrated by same marks. Below, the example, in which the charge and discharge control device 100 of the battery detects the unplanned use at a time 10:00 as indicated by arrow in the charge and discharge state SG1 in FIG. 8A, will be explained.

FIG. 8A indicates the charge and discharge control plan PL1a which is created at a time 9:00 of 2013/1/31 (2013 year January 31). In the charge and discharge control plan PL1a, about the PC1, the electricity state AC (a block marked by horizontal stroke left to right) is appointed from 9:00 to 13:30 and from 16:30 to 17:00, the electric discharge state BA (a block marked by rising diagonal stroke from top right to bottom) is appointed from 13:30 to 16:30 and the charge state CH (a block marked by vertical stroke from top to bottom) is appointed from 17:00 to 18:00. The state acquisition unit 131 acquires, for example, the charge and discharge state of each notebook PC 30 at every 30 minutes and stores the acquired state in the charge and discharge state history table T1 (referring to FIG. 8B). In the example, the state acquisition unit 131 acquires the electricity state AC at 9:00 and at 9:30 and the electricity discharge state BA at 10:00, as illustrated in the charge and discharge state SG1 in FIG. 8A.

The unplanned use detecting unit 132 extracts the unplanned use entry including 2013/1/31 10:00 between the start time and the end time from the unplanned use history list IL (S3-2), because the charge and discharge state “electricity discharge state BA” which is acquired at 10:00 is different from the charge and discharge state “electricity state AC” appointed in the charge and discharge control plan PL1a (NO/S3-1). In the example, because the unplanned use entry including 2013/1/31, 10:00 does not exist in the unplanned use history list IL at 10:00, the unplanned use detecting unit 132 newly makes the unplanned use entry e1-1 indicated to a dotted line in the unplanned use history list IL1 in FIG. 8A. As indicated to the unplanned use entry e1-1 in FIG. 8A, the unplanned use entry e1-1 has the start time “1/31 10:00”, the end time “blank”, the acquisition state “electricity discharge state BA” and the plan state “electricity state AC”.

Then the estimation unit 136 calculates the duration time of the unplanned use (S4-1). Because the unplanned use entry e1-1 is an unplanned use entry made newly, the duration time is 0 hours. The estimation unit 136 extracts the unplanned use entry which has same acquisition state “electricity discharge state BA” and same plan state “electric state AC” as the newly unplanned use entry e1-1 from the unplanned use history list Ill (S4-2). In the unplanned use history list IL1, four unplanned use entries e1-2 of “2013/1/27 from 10:30 to 11:30”, “2013/1/28 from 10:30 to 12:00”, “2013/1/29 from 10:00 to 11:30” and “2013/1/30 from 10:00 to 11:30” has same acquisition state and the plan state as the newly unplanned use entry e1-1. Therefore, the estimation unit 136 extracts each of the unplanned use entries e1-2 of 2013/1/27-1/30 from the unplanned use history list ILL

Then the estimation unit 136 estimates the duration time and the charge and discharge state of the unplanned use entry e1-1 currently in progress based on the unplanned use entries e1-2 of “2013/1/27-1/30” which are extracted (YES/S4-3, S4-4, S4-5). Specially, the estimation unit 136 estimates 1.5 hours which is longest duration time as the duration time of the unplanned use currently in progress among each of duration times of the unplanned use entries e1-2 of “2013/1/27-1/30” (S4-4). Therefore, the estimation unit 136 sets a time “11:30” (not illustrated in FIG. 8A) in which the duration time 1.5 hours is added to the start time 10:00 into the end time of the unplanned use entry e1-1 currently in progress.

In addition, the estimation unit 136 estimates the charge and discharge state in the duration time of the unplanned use entry e1-1 currently in progress (S4-5). In the charge and discharge state history table ST1 of the PC1 in FIG. 8A, a time band indicated by a block marked by a cross line and indicated by a block marked by horizontal stroke from right to left, are a time band corresponding to the unplanned use entries e1-2 in the unplanned use history list IL1. In the charge and discharge state history table ST1 of the PC1, the charge and discharge state at the time band after progress for 30 minutes from the start time, that is, “2013/1/27 11:00”, “2013/1/28 11:00”, “2013/1/29 10:30”, and “2013/1/30 10:30”, are three electricity discharge state BA and one electricity state AC. Because there is the most electric discharge state BA, the estimation unit 136, as illustrated by the estimation information SP1 in FIG. 8B, estimates that the charge and discharge state in the time band (from 10:30 to 11:00) after progress for 30 minutes of the unplanned use entry currently in progress, is the electric discharge state BA. Similarly, the estimation unit 136 estimates that the charge and discharge state in the time band (from 11:00 to 11:30) of the unplanned use entry currently in progress is the electric discharge state BA.

In addition, the estimation unit 136 may limit the unplanned use entry e1-2 to extract into the unplanned use entry in the fixed period, or may limit the unplanned use entry e1-2 into the unplanned use entry same day of week and the time band (the morning, the afternoon) as the unplanned use entry currently e1-1. Or, the estimation unit 136 may extract the unplanned use entry as same start time as the unplanned use entry e1-1 currently in progress. For example, the estimation unit 136 extracts the unplanned use entries of “2013/1/29 from 10:00 to 11:30” and “2013/1/30 from 10:00 to 11:30” which has same start time as the unplanned use entry e-1. It is possible that the estimation unit 136 extracts the unplanned use entry which has same state as the unplanned use currently in progress by narrowing down the target unplanned use entry to extract. Therefore, it is possible that the estimation unit 136 precisely estimates the duration time and the charge and discharge state of the unplanned use based on the unplanned use entry which is higher in similarity in the state of the unplanned use.

Next, the plan correction unit 137 selects one or more notebook PCs 30 having the estimated charge and discharge state (discharge state BA) in the estimated duration time from 10:00 to 11:30 in the charge and discharge control plan PL1a (S5-1). In the charge and discharge control plan PL1a in FIG. 8, the notebook PC3 and PC4 have the discharge state BA from 10:00 to 11:30. Accordingly, the plan correction unit 137 selects the notebook PC3 and PC4 for cancelling the influence by the unplanned use by the notebook PC1.

In addition, for example, when the notebook PC3 and PC4 have the unplanned use in which the duration time overlaps with the unplanned use currently in progress, the plan correction unit 137 excludes the notebook PC3 and PC4 from the selection of the notebook PC 30 for cancelling the influence (S5-1). Further, the plan correction unit 137, when the notebook PC 30 to be selected is not found (NO/S5-2), may select the notebook PC2 where the electric discharge state BA is appointed from 10:00 to 10:30 and the PC5 where the electric discharge state BA is appointed from 10:30 to 11:30 (S5-3).

And the plan correction unit 137 re-creates the charge and discharge control plan PL of three notebook PCs (PC1, PC3, PC4) after 10:30. For example, the plan correction unit 137 corrects to the discharge state BA from 10:00 to 11:30 in the charge and discharge control plan PL1b of the PC1, corrects to the electricity state AC from 11:00 to 11:30 in the charge and discharge control plan PL1b of the PC3 and corrects to the electricity state AC from 10:00 to 11:00 in the charge and discharge control plan PL1b of the PC4. In the embodiment, it is a premise to be equal in specifications of each notebook PC 30.

In addition, when the charge and discharge state from 10:00 to 11:30 in the charge and discharge control plan PL1b of the PC1 is corrected to the discharge state BA from the electricity state AC, the battery residual amounts of the PC1 may be insufficient. Therefore, the control of the electric discharge state BA appointed from 13:30 to 16:30 may not be performed. Therefore, plan correction unit 137 corrects the charge and discharge state from 13:30 to 14:00 and from 16:00 to 16:30 in electricity state AC from electric discharge state BA in the charge and discharge control plan PL1b of the PC1 in order to avoid battery short. In addition, in response to this correction, the plan correction unit 137 corrects the charge and discharge state from 13:30 to 14:00 in electricity discharge state BA from electricity state AC in the charge and discharge control plan PL1b of the PC3 and corrects the charge and discharge state from 16:00 to 16:30 in electricity discharge state BA from electricity state AC in the charge and discharge control plan PL1b of the PC4. It is possible that the plan correction unit 137 controls surely each notebook PC 30 based on the charge and discharge control plan PL1b by correcting the charge and discharge state of the time except the duration time of the unplanned use.

In addition, when the correction of the charge and discharge control plan PL is failed (NO/S5-6), the plan correction unit 137 may correct the charge and discharge control plan PL1b by further targeting five notebook PC 30 including the PC2 and the PC5.

In addition, in a specific example, process when acquiring the charge and discharge state of the notebook PC 30 again at 10:30 will be explained. The unplanned use detecting unit 132, when acquiring the charge and discharge state, for example, “electricity state AC” at 10:30, detects the unplanned use by being different from the charge and discharge state “electric discharge state BA” appointed in the charge and discharge control plan PL1b (NO/S3-1). Then the unplanned use detecting unit 132 extracts the unplanned use entry which is already created at 10:00 from the unplanned use history list IL1 (S3-2), and calculates “0.5 hours” as the already duration time (S4-1). And the estimation unit 136 extracts the unplanned use entry “2013/1/29 from 10:00 to 11:30” from the unplanned use history list IL1 (S4-2). Because in the other unplanned use entries “2013/1/27 from 10:30 to 11:30”, “2013/1/28 from 10:30 to 12:00”, and “2013/1/30 from 10:00 to 11:30”, the charge and discharge state from 10:30 to 11:00 are the discharge state BA, the estimation unit 136 does not extract these unplanned use entries.

On the other hand, for example, the unplanned use detecting unit 132, when acquiring the charge and discharge state “electricity discharge state BA” at 10:30, does not detect the unplanned use by being same as the charge and discharge state “electric discharge state BA” appointed in the charge and discharge control plan PL1b (YES/S3-1). Further, the unplanned use detecting unit 132 does not perform the process in the step S3-4, because there is not the unplanned use entry which is not yet set the end time.

In addition, the plan correction unit 137 does not correct the charge and discharge control plan PL1a when the peak electricity does not increase by the unplanned use or when the peak electricity does not exceed a predetermined limit level. Specially, the estimation unit 136 calculates the peak electricity when the unplanned use occurred as estimated based on the charge and discharge control plan PL1a after estimating the duration time and the charge and discharge state of the unplanned use. And the estimation unit 136 does not perform re-creating process (S5-1-S5-8) of the charge and discharge control plan PL1a when the calculated peak electricity does not exceed the peak electricity without correcting the charge and discharge control plan PL1a or when the calculated peak electricity does not exceed a predetermined limit level. It is possible that the plan correction unit 137 reduces load by the re-creation of the charge and discharge control plan PL1a becoming needless.

As described above, the charge and discharge control device 100 according to the first embodiment, has a charge and discharge acquisition unit which acquires the charge and discharge state including a discharge state, an electricity state and a charge state of the battery, and an unplanned use detecting unit which detects a first unplanned use when the acquired charge and discharge state is different from the charge and discharge state appointed in the charge and discharge control plan. And the charge and discharge control device 100 has an estimation unit which estimates a duration time and charge and discharge state of the first unplanned use based on an unplanned use entry which is corresponding to the first unplanned use and stored in an unplanned use history list of a first battery which is detected the unplanned use. Further, the charge and discharge control device 100 has a control plan correction unit which corrects the charge and discharge control plan of the first battery so as to have the estimated charge and discharge state in the estimated duration time of the first unplanned use and corrects the charge and discharge control plan of the second battery having the estimated duration time and the estimated charge and discharge state corresponding to a correction of the charge and discharge control plan of the first battery.

It is possible that the charge and discharge control device 100 of the battery estimates the charge and discharge state which is more likely to occur by the unplanned use by being based on the unplanned use history list IL. And the charge and discharge control device 100 of the battery corrects the charge and discharge control plan PL which is detected the unplanned use to have the estimated charge and discharge state in the estimated duration and corrects the charge and discharge control plan PL of the different battery for cancelling an increment of the consumption electricity by the unplanned use. It is possible that the charge and discharge control device 100 of the battery surely suppresses the peak electricity when the unplanned use of the battery occurs. In addition, it is possible that the charge and discharge control device 100 of the battery quickly corrects the charge and discharge control plan PL by correcting the charge and discharge control plan of only some batteries including the battery which is detected the unplanned use.

In addition, the battery, of which the consumer has, has the original introduction purpose such as power supplies for moving if it is EV or for driving the notebook PC by the battery when going out. It is possible that the charge and discharge control device 100 of the battery according to the embodiment suppresses the peak electricity surely without disagreeing with the original introduction purpose of the battery by correcting the charge and discharge control plan PL based on the unplanned use occurring depending on the original introduction purpose of the battery.

In addition, in the charge and discharge control device 100 of the battery according to the first embodiment, the control plan correction unit corrects the charge and discharge control plan PL of the second battery so that the peak electricity based on a plural charge and discharge control plan PL including the charge and discharge control plans of the first and second batteries does not exceed the peak electricity when the charge and discharge control plans of the first and second batteries are not corrected or does not exceed an appointed limit level. Therefore, it is possible that the charge and discharge control device 100 suppresses the number of the target second battery and their correction ranges in the time band for cancelling the influence into a few number, because flexibly correcting the charge and discharge control plan.

In addition, in the charge and discharge control device 100 of the battery according to the first embodiment, the control plan correction unit corrects the charge and discharge state in the time band except the estimated duration time in the charge and discharge control plan PL of the first battery so as to perform controlling the estimated charge and discharge state in the estimated duration time. Therefore, it is possible that the charge and discharge control device 100 surely controls the battery based on the charge and discharge control plan PL and suppresses the peak electricity.

In addition, in the charge and discharge control device 100 of the battery according to the first embodiment, the control plan correction unit does not correct the charge and discharge control plan PL of the first battery when the peak electricity based on the charge and discharge control plan PL of the first battery, when the estimated charge and discharge state in the estimated duration time of the first unplanned use occurs, does not exceed the peak electricity when the charge and discharge control plan PL of the first battery is not corrected. Therefore, it is possible that the charge and discharge control device reduces a load of the process by omitting the correction of the charge and discharge control plan PL when the influence does not occur in the peak electricity.

In addition, in the charge and discharge control device 100 of the battery according to the first embodiment, the estimation unit estimates the duration time and charge and discharge state of the first unplanned use based on the unplanned use entry which has same acquired charge and discharge states and planned charge and discharge state as the first unplanned use at the time of detection. Therefore, it is possible that the charge and discharge control device 100 of the battery estimates the duration time and the charge and discharge state of the unplanned use which is detected based on the unplanned use entry which has same or similar state as the unplanned use which is detected.

In addition, in the charge and discharge control device 100 of the battery according to the first embodiment, the estimation unit estimates the longest duration time as the duration time of the first unplanned use among duration times of extracted unplanned use entry. Therefore, it is possible that the charge and discharge control device 100 raises the probability to control as scheduled according the charge and discharge control plan PL, because estimating the duration time by assuming that the unplanned use continues for the longest time.

In addition, in the charge and discharge control device 100 of the battery according to the first embodiment, the estimation unit estimates the most charge and discharge state as the charge and discharge state of the first unplanned use among the charge and discharge states in the duration time of the extracted unplanned use entry. Therefore, it is possible that the charge and discharge control device 100 raises the probability to control as scheduled according the charge and discharge control plan PL, because estimating most charge and discharge state as the charge and discharge state among the similar unplanned use entries. Accordingly, it is possible to surely suppress the peak electricity.

In addition, in the first embodiment, the second battery is a battery that the unplanned use does not occur in duration time for the first unplanned use. In other words, the charge and discharge control device 100 of the battery excludes the battery which is detected the unplanned use that the estimated duration time overlaps from the target batteries for cancelling the influence by the unplanned use of the first battery. Therefore, it is possible that the charge and discharge control device 100 surely selects the battery for cancelling the influence when correcting the charge and discharge control plan PL and reduces the peak electricity.

### Second Embodiment

In the first embodiment, the process, which corrects the charge and discharge control plan PL for some notebook PCs 30 when the unplanned use is detected, was explained. In contrast, the charge and discharge control device 100 of the battery according to the second embodiment, before periodically creating the charge and discharge control plan PL, detects the unplanned use, estimates the unplanned use information (duration and charge and discharge state) and creates the charge and discharge control plan PL which is applied the estimated information of the unplanned use. The charge and discharge control device 100 of the battery according to the second embodiment creates the charge and discharge control plan PL which is incorporated the estimated information for the unplanned use about all notebook PCs 30.

The hardware constitution and the block configuration of the charge and discharge control device 100 of the battery according to the second embodiment are similar to that in the first embodiment, thereby the explanation are omitted.

(Process of the Second Embodiment)

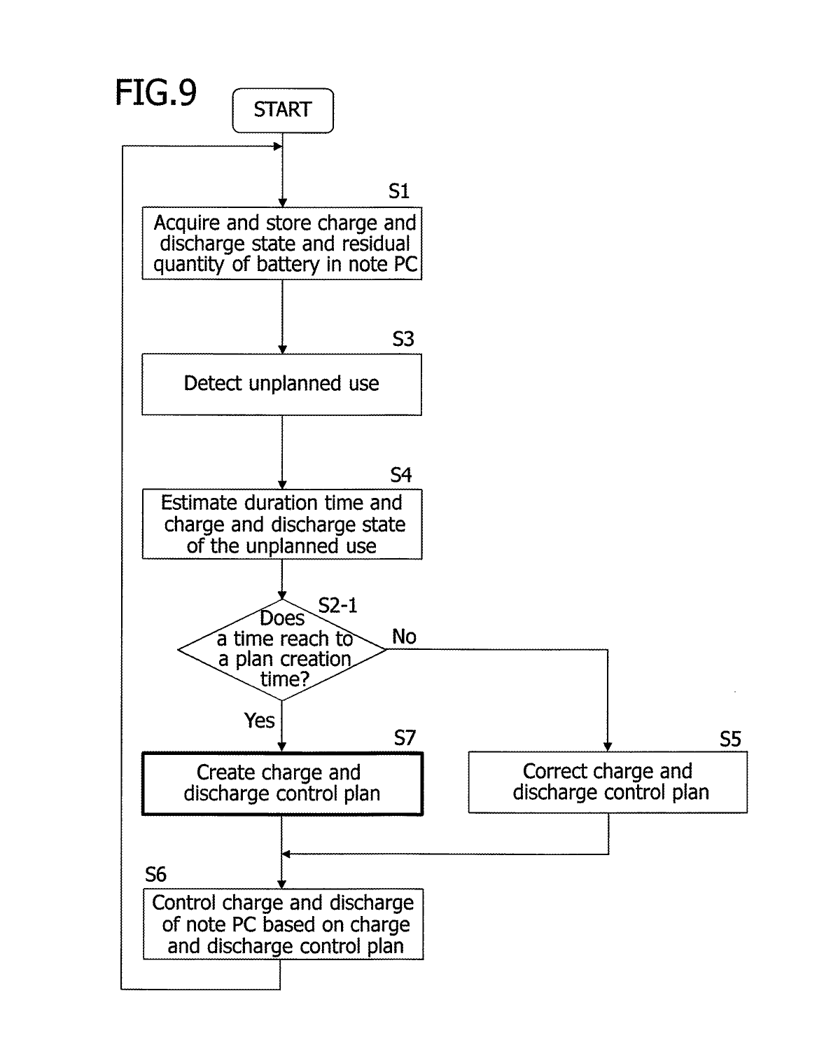

FIG. 9 is a diagram of a flow chart explaining the process of the charge and discharge control device 100 of the battery according to the second embodiment. In FIG. 9, same steps as in FIG. 6 indicate the same symbols. The process in the step S1 is similar to the step S1 of the first embodiment. In the second embodiment, the unplanned use detecting unit 132 detects the unplanned use regardless of having reached at the creation time of the charge and discharge control plan PL following the step S1 (S3). The estimation unit 136, when detecting the unplanned use, estimates the duration time of the unplanned use which is detected and the charge and discharge state in the estimated duration time with reference to the charge and discharge state history table ST based on the unplanned use history list IL of the notebook PC 30 which is detected the unplanned use (S4).

When a time reaches at the creation time of the charge and discharge control plan PL (YES/S2-1), the plan creation unit 133 creates the charge and discharge control plan PL having the estimated information for the unplanned use which is detected, so that the peak electricity becomes small in consideration of an electricity demand prediction, specifications of each notebook PC 30, current charge and discharge state and battery residual quantity (S7). In other words, in the second embodiment, the unplanned use is detected before the creation of the charge and discharge control plan PL and the duration time and the charge and discharge state of the unplanned use are estimated beforehand. And the charge and discharge control plan creation unit 133 creates the charge and discharge control plan PL of all notebook PC 30 based on the estimated information for the unplanned use.

When a time does not reach at the creation time of the charge and discharge control plan PL (NO/S2-1), the charge and discharge control plan PL of some notebook PCs 30 are corrected as similar to the first embodiment (S5). And the state control unit 135 controls the battery of each PC based on the created charge and discharge control plan PL or the corrected charge and discharge control plan PL (S6).

The creation process S7 of charge and discharge control plan PL in FIG. 9 will be explained in detail.

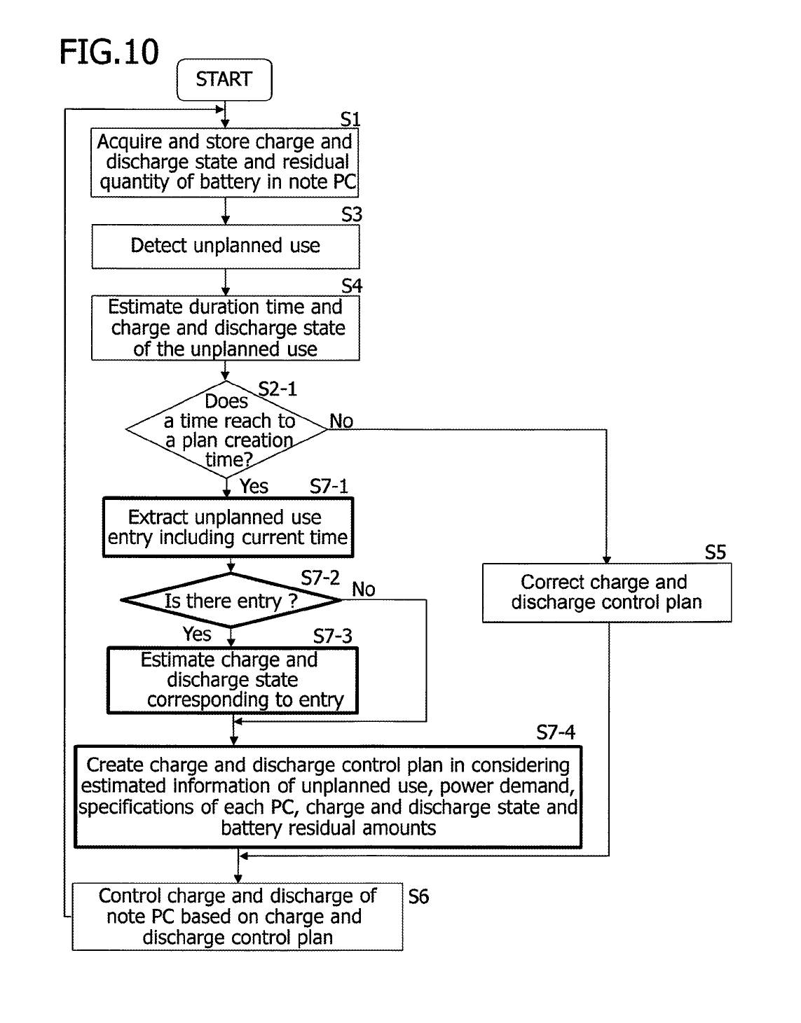

FIG. 10 is a diagram of a flow chart explaining the processes of the charge and discharge control device 100 of the battery in the second embodiment in detail. In FIG. 10, same steps as in FIG. 6 and FIG. 10 indicate the same symbols. Each process in the steps S1-S6 is similar to the steps S1-S6 in the first embodiment as described in FIG. 6, therefore, explanations of these similar steps are omitted.

When a time reaches to the creation time of the charge and discharge control plan PL (YES/S2-1), the unplanned use detecting unit 132 extracts the unplanned use entry including the current time between the start time and the end time from the unplanned use history list IL of the notebook PC 30 which is detected the unplanned use (S7-1). This process corresponds with the process in the step S3-2 in the first embodiment as illustrated in FIG. 7. When there is the unplanned use entry which is extracted (YES/S7-2), the unplanned use are currently progressing and the battery of the notebook PC 30 are controlling based on the charge and discharge control plan PL after correcting based on the unplanned use information which is estimated. Therefore, estimation unit 136 estimates the duration time and the charge and discharge state in the charge and discharge control plan PL after correcting as the duration time and the charge and discharge state of the unplanned use currently in progress (S7-3).

Then the plan creation unit 133 creates the charge and discharge control plan PL so that the peak electricity becomes small in consideration of an electricity demand prediction, the specifications of each notebook PC 30, the current charge and discharge state and the battery residual quantity, as same as the step S2-2 in the first embodiment as illustrated in FIG. 7 (S7-4). In addition, the plan creation unit 133 creates the charge and discharge control plan PL to satisfy the estimated duration time and the estimated charge and discharge state of the unplanned use.

Next, the process of charge and discharge control device 100 of the battery according to the second embodiment as described in FIG. 9 and FIG. 10 will be explained based on a specific example.

(Specific Example)

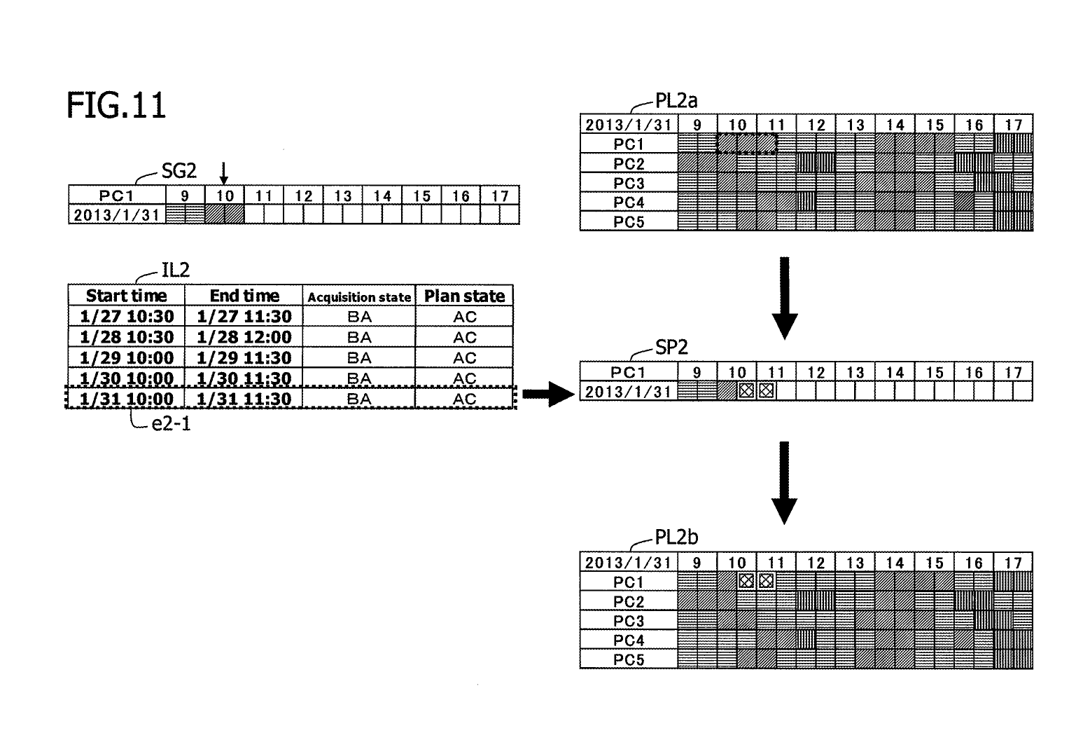

FIG. 11 is a diagram explaining specific examples of the processes of the charge and discharge control device 100 of the battery according to the second embodiment. In FIG. 11, same portions as FIG. 4 and FIG. 8A, FIG. 8B are illustrated by same marks. In the example, a case, which creates the charge and discharge control plan PL at 2013/1/31 10:30 after corrected the charge and discharge control plan PL at 2013/1/31 10:00, will be explained. FIG. 11 illustrates examples of the charge and discharge state SG2 which is acquired, the unplanned use history list IL2, the estimated unplanned information SP2 for the PC1, a first and second charge and discharge control plans PL2a, PL2b of the PC1-PC5. The first charge and discharge control plan PL2a indicates the charge and discharge control plan PL which has been created at 10:00, the second charge and discharge control plan PL2b indicates the charge and discharge control plan PL which has been created at 10:30.

As described in the first embodiment, the unplanned use detecting unit 132 detects the unplanned use at 10:00 and creates the unplanned use entry “2013/1/31 from 10:00 to 11:30” of PC1. Therefore, the unplanned use detecting unit 132 extracts the unplanned use entry e2-1 “2013/1/31 from 10:00 to 11:30” from the unplanned use history list IL2 of PC1 at 10:30 (S7-1). And, as depicted by the estimated information SP2 in FIG. 11, the charge and discharge control plan creation unit 133 estimates that the PC1 becomes the electric discharge state BA from 10:30 to 11:30, based on the duration time and charge and discharge state which is estimated at 10:00 (S7-3). And the plan creation unit 133 appoints the electric discharge state BA from 10:30 to 11:30 of the PC1, and creates the charge and discharge control plan PL2b that the peak electricity becomes small (S7-4).

In addition, as described above, the plan creation unit 133 estimates that the PC1 becomes the electric discharge state BA due to the unplanned use from 10:30 to 11:30 (S7-3). Therefore, because a time band “from 10:30 to 11:30” of the charge and discharge control plan PL2b of the PC1 is a time band in which the unplanned use is currently progressing, the plan correction unit 137, even when other notebook PC 30 detect the unplanned use at from 10:30-11:30 (NO/S3-1), does not select the PC1 as the notebook PC that cancels the influence of the unplanned use of the other notebook PC 30. It is possible that the plan correction unit 137 surely selects the notebook PC 30 which cancels the influence by excluding the notebook PC 30 which is detected unplanned use from a selection candidate of the notebook PC 30 cancelling the influence of the unplanned use, thereby it is possible to reduce the peak electricity.

As described above, the charge and discharge control device 100 of the battery according to the second embodiment has the plan creation unit which creates the charge and discharge control plans PL of plural batteries so that the peak electricity based on the charge and discharge control plans of plural batteries becomes small. And the plan creation unit creates the charge and discharge control plan PL so that the charge and discharge control plan PL of first battery has the estimated charge and discharge state in the estimated duration time of the first unplanned use.

Therefore, the charge and discharge control device 100 of the battery according to the second embodiment estimates the charge and discharge state which is more likely to produce due to the unplanned use, before creation of the charge and discharge control plan PL, beforehand and creates the charge and discharge control plan PL which is considered the charge and discharge state which is estimated. Thereby, it is possible that the charge and discharge control device 100 raises the realization of the charge and discharge control plan PL, and suppresses the peak electricity more surely.

In addition, in the second embodiment, the second battery in the plan correction unit is a battery that the unplanned use does not occur in the duration time of the first unplanned use. In other words, the charge and discharge control device 100 of the battery excludes a battery having the unplanned use detected at the time of creation of the charge and discharge control plan PL from the target batteries for cancelling the influence by the unplanned use which occurs newly. Therefore, it is possible that the charge and discharge control device 100 surely selects the battery for cancelling the influence when correcting the charge and discharge control plan PL and reduces peak electricity.

In addition, in the charge and discharge control device 100 of the battery according to the second embodiment, the plan creation unit can create the charge and discharge control plan PL without considering the estimate information of the unplanned use, when the peak electricity does not exceed the peak electricity in a case of occurring the estimated charge and discharge state in the estimated duration time of the first unplanned use in the charge and discharge control plan PL which is not considered the estimated information of the first battery. Therefore, it is possible that the charge and discharge control device 100 of the battery creates the charge and discharge control plan PL more flexible by disregarding the estimated information of the unplanned use, when the peak electricity does not increase due to the unplanned use.

### Third Embodiment

The charge and discharge control device 100 of the battery according to the first embodiment, corrects the charge and discharge control plan PL based on the estimated information of the unplanned use when the unplanned use is detected. In contrast, the charge and discharge control device 100 of the battery according to the third embodiment detects the unplanned use which has a possibility of occurrence after passed a predetermined time and corrects the charge and discharge control plan PL based on information of the estimated unplanned use. It is possible that the charge and discharge control device 100 of the battery estimates the unplanned use which has a possibility of occurrence in a former time and corrects the charge and discharge control plan PL of notebook PC 30 before the unplanned use occurs.

In the third embodiment, the hardware constitution and block configuration of the charge and discharge control device 100 of the battery are similar to that in the first embodiment, and are omitted to explain.

(Processes of the Third Embodiment)

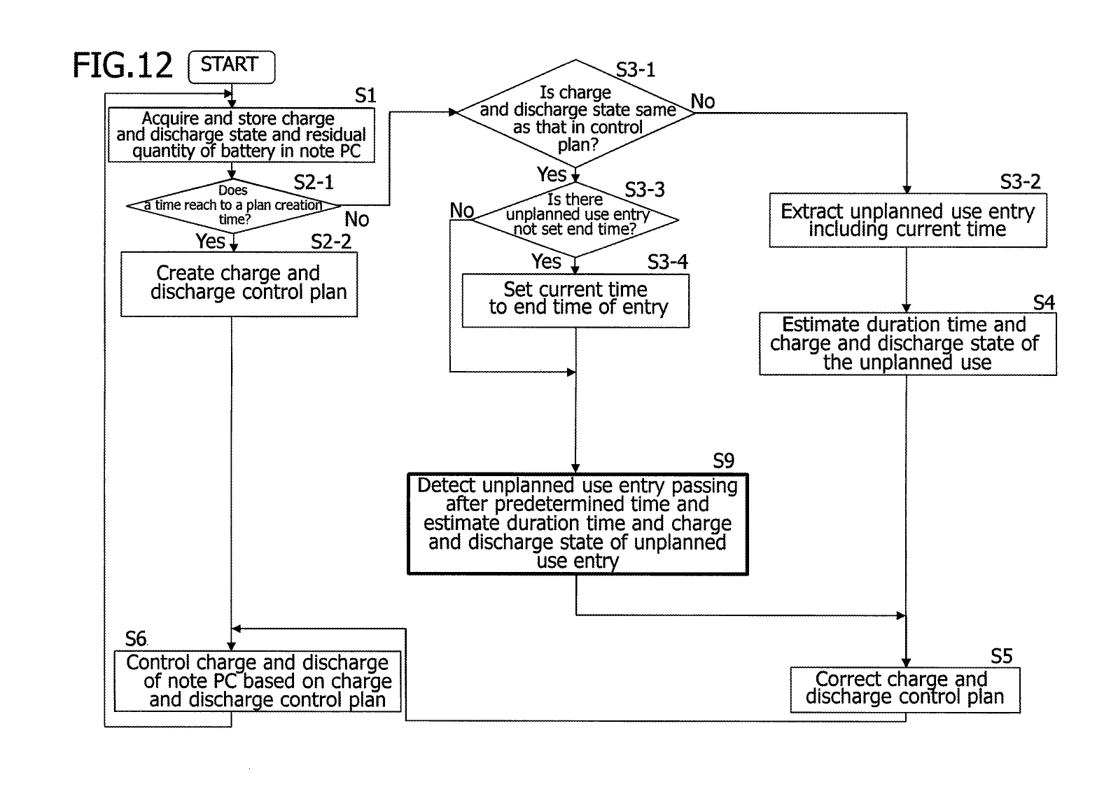

FIG. 12 is a diagram of flow chart explaining a flow of the processes of the charge and discharge control device 100 of the battery according to the third embodiment. In FIG. 12, same steps as in FIG. 6 and FIG. 7 are marked by same symbol. That is, the processes in the step S1—the step S6 are similar to that in the first embodiment (FIG. 6 and FIG. 7). The unplanned use detecting unit 132 according to the third embodiment, when the unplanned use is not detected (YES/S3-1), judges whether or not the unplanned use is possible to occur after passed a predetermined time. As described in the first embodiment, the unplanned use detecting unit 132 judges whether or not the acquired charge and discharge state is same as the charge and discharge state appointed in the charge and discharge control plan PL by comparing these charge and discharge states (S3-1), and does not detect the unplanned use when both are same (YES/S3-1). And the unplanned use detecting unit 132 sets the current time to the end time (S3-4) when there is an unplanned use entry in which the end time is not set (YES/S3-3).

Then, the unplanned use detecting unit 132 and the estimation unit 136 according to the third embodiment detects the unplanned use which is possible to occur after passed a predetermined time and estimates the duration time and the charge and discharge state of the unplanned use which is detected (S9). And plan correction unit 137 corrects the charge and discharge control plan PL of the notebook PC 30 which is detected the unplanned use, which is possible to occur after passed a predetermined time, so as to have the estimated charge and discharge state in the estimated duration time and corrects the charge and discharge control plan PL of the other notebook PC 30 for cancelling the influence on the consumption electricity by the unplanned use (S5).

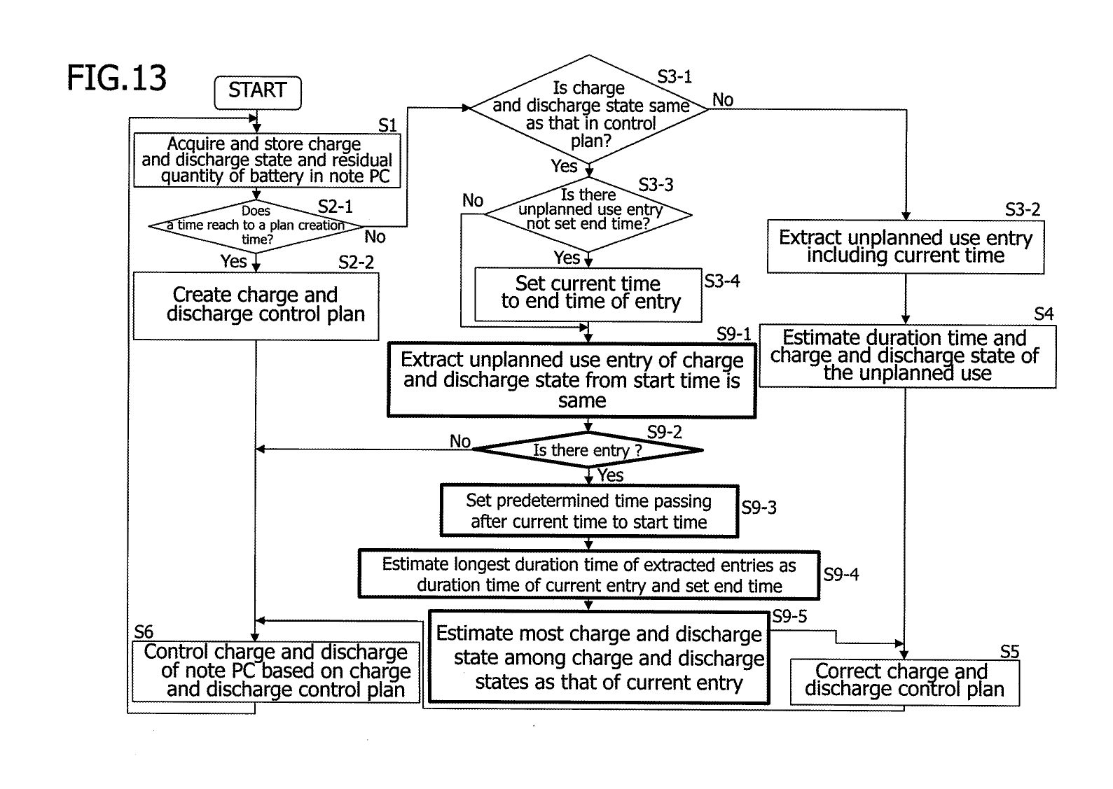

FIG. 13 is a diagram of flow chart explaining the processes of the charge and discharge control device 100 of the battery in FIG. 12 in greater detail. In FIG. 13, same steps as in FIG. 12 are marked by same symbol. That is, in FIG. 13 illustrates the processes of the step S9 in FIG. 12 in greater detail.

Specially, in the step S9, the unplanned use detecting unit 132 extracts the unplanned use entry from the unplanned use history list IL and refers to the charge and discharge states of each of the extracted unplanned use entries at the predetermined time before the start time of the unplanned use entry (referring to the start time in the unplanned use history list IL) from the charge and discharge state history table ST. Then, the unplanned use detecting unit 132 extracts the unplanned use entry in which the charge and discharge state at a predetermined time before the start time of the unplanned use entry is same as the charge and discharge state, which is acquired currently, from the unplanned use history list IL (S9-1). And, the unplanned use detecting unit 132, when there is the unplanned use entry which is extracted (YES/S9-2), determines that the unplanned use is a possibility to occur after passing the predetermined time. On the other hand, when there is not the unplanned use entry which is extracted (NO/S9-2), the unplanned use detecting unit 132 determines that the unplanned use does not occur after passing the predetermined time. In addition, the unplanned use detecting unit 132 may judge that the unplanned use occurs after passing the predetermined time only when extracting the unplanned use entries more than a constant number (YES/S9-2). Thereby, it is possible that the unplanned use detecting unit 132 determines whether the unplanned use occurs with a high precision.

When there is the unplanned use entry which is extracted (YES/S9-2), the estimation unit 136 estimates the duration time and the charge and discharge state of the unplanned use which occurs after passing the predetermined time based on the unplanned use entry after passing the predetermined time which is extracted. At first, estimation unit 136 sets the start time of the unplanned use by the time after passing the predetermined time from the current time (S9-3). And the estimation unit 136, as same as an example of the first embodiment, estimates the duration time by assuming a case that the unplanned use continues for longest time based on the unplanned use entry which is extracted (S9-4). In addition, the estimation unit 136, as same as an example of the first embodiment, acquires each of the charge and discharge state from the start time to the end time, from the unplanned use entries which are extracted. And the estimation unit 136 estimates the charge and discharge state where there is the most after passing the predetermined time from the start time, as the charge and discharge state after passing the predetermined time from the start time of the unplanned use which occurs after passing the predetermined time (S9-5).

And the plan correction unit 137 corrects the charge and discharge control plan PL of the notebook PC 30 which is detected the unplanned use which occurs after passing the predetermined time so as to have the charge and discharge state which is estimated in the estimated duration time. And the plan correction unit 137 corrects the charge and discharge control plan PL of the other notebook PC 30 so as to cancel the increase and decrease of the consumption electricity by the correction of the charge and discharge control plan PL of the notebook PC 30 which is detected the unplanned use (S5).

In addition, the plan correction unit 137, as same as the first embodiment, may not correct the charge and discharge control plan PL when the peak electricity, in a case of occurring the unplanned use according to the estimation in the charge and discharge control plan PL, does not exceed peak electricity when the charge and discharge control plan PL is not corrected. It is possible that the charge and discharge control plan correction unit 137 reduce load by re-creating of the charge and discharge control plan PL becoming needless.

In addition, in the flow chart in FIG. 12 and FIG. 13, a case, that the charge and discharge control device 100 corrects some charge and discharge control plan PL including the notebook PC 30 which is occurred the unplanned use based on the unplanned use after the progress in the scheduled time, which is extracted, was described. However, as same as the second embodiment, the charge and discharge control device 100 may create the charge and discharge control plans PL of all notebook PC 30 based on the estimated unplanned after the progress at the appointed time.

Next, the process of charge and discharge control device 100 of the battery according to the third embodiment as described in FIG. 12 and FIG. 13 will be explained based on a specific example. For example, the scheduled time in the specific example is 30 minutes.

(Specific Example)

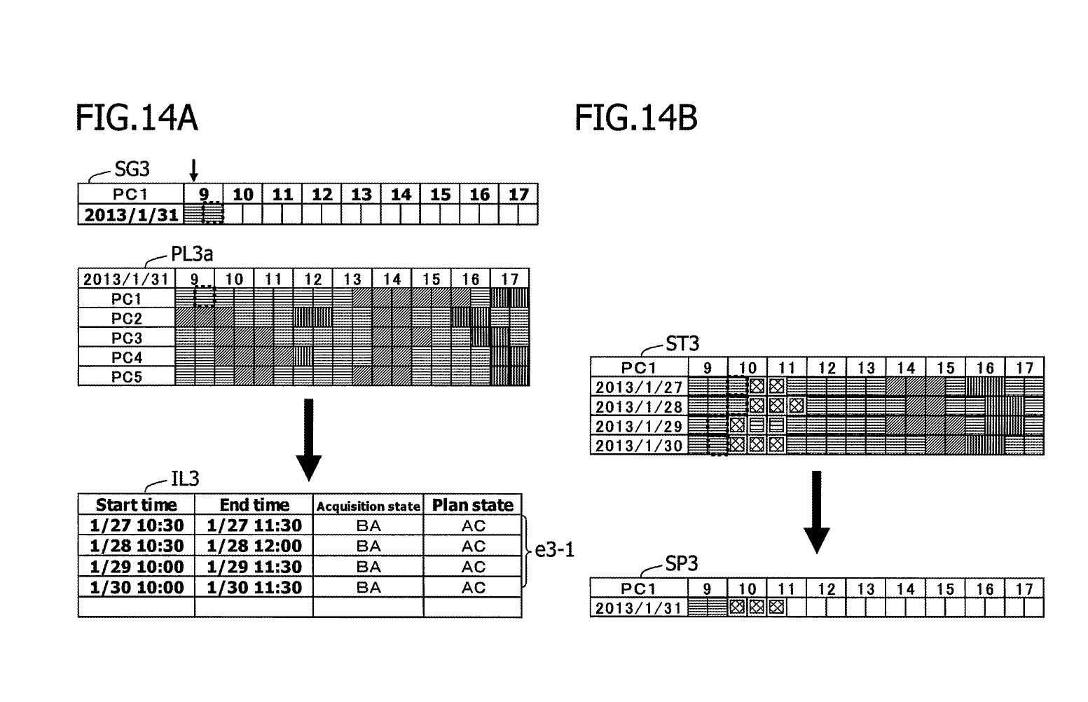

FIG. 14A and FIG. 14B are diagrams explaining specific examples of the processes of the charge and discharge control device 100 of the battery according to the third embodiment. In FIG. 14A and FIG. 14B, same portions as FIG. 4 and FIG. 8A, FIG. 8B are illustrated by same marks. In the example, a case, in which the charge and discharge control device 100 estimates the unplanned use of the PC1 which will occur from 10:00 at the time 2013/1/31 09:30, will be explained. FIG. 14A illustrates examples of the charge and discharge state SG3 which is acquired, the first charge and discharge control plan PL3a, and the unplanned use history list IL3. FIG. 14B illustrates the estimated information SP3 for the PC1, and the charge and discharge state history table ST3.

According to an example in FIG. 14A, the charge and discharge state SG3 of the PC1 indicates the electricity state AC of the PC1 which is acquired at 9:30 (indicated by a mark “arrow” in FIG. 14A). While, the charge and discharge state at 9:30 in the charge and discharge control plan PL3a of the PC1 also indicates the electricity state AC. That is, at acquired time 9:30, both charge and discharge states are same. Therefore, the unplanned use detecting unit 132 does not detect the unplanned use (YES/S3-1). And the unplanned use detecting unit 132 extracts the unplanned use entry, of which the charge and discharge state for 30 minutes before the start time of the unplanned use entry is same as the charge and discharge state which is acquired for 30 minutes (in the specific example, from 9:30 to 10:00), from the unplanned use history list IL3 in FIG. 14A. According to the charge and discharge state SG3 in FIG. 14, the charge and discharge state of PC1 which is acquired from 9:30 to 10:00 is the electricity state AC. Therefore, the unplanned use detecting unit 132 extracts four unplanned use entries e3-1 of “2013/1/27 from 10:30 to 11:30”, “2013/1/28 from 10:30 to 12:00”, “2013/1/29 from 10:00 to 11:30” and “2013/1/30 from 10:00 to 11:30”, in which the charge and discharge state for 30 minutes before the start time (10:30 and 10:00) is the electricity state AC (as indicated by dotted border in the charge and discharge state history table ST3) (YES/S9-2).

In embodiments, the unplanned use detecting unit 132 determines that the unplanned use is possible to occur at 30 minutes later because there is the unplanned use entry e3-1 to extract (YES/S9-2). Therefore, the estimation unit 136 sets the start time of the unplanned use at 10:00 which is 30 minutes later (S9-3). Then, the estimation unit 136 estimates the duration time of the unplanned use as 1.5 hours which is the longest duration time among each of duration times of the unplanned use entries e3-1 which are extracted (S9-4). Therefore, the end time of the unplanned use occurring from 10:00 is “2013/1/31 11:30”. In addition, the estimation unit 136 acquires the charge and discharge state in the duration time of the unplanned use entry e3-1 which is extracted by referring the charge and discharge state history table ST3 in FIG. 14B and estimates that the charge and discharge state of the unplanned use is the electric discharge state BA which is most (S9-5). Therefore, the estimation unit 136 estimates that the PC1 becomes to the electric discharge state BA during 2013/1/31 from 10:00 to 11:30, as illustrated hatched line block in the estimation information SP3.

And the plan correction unit 137 corrects the charge and discharge state in 2013/1/31 from 10:00 to 11:30 of the charge and discharge control plan PL of the PC1 in the electric discharge state BA, and corrects the charge and discharge control plan PL of different notebook PC 30 to cancel the increase and decrease of the consumption electricity by the correction of the charge and discharge control plan of the PC1.

In addition, as same as the first embodiment, the unplanned use detecting unit 132 may limit the unplanned use entry e3-1 to extract in the step S9-1, into the unplanned use entry in the fixed period, or may limit the unplanned use entry e3-1 into the unplanned use entry same day of week and the time band (the morning, the afternoon) as the unplanned use which is detected. Or, the unplanned use detecting unit 132 may extract the unplanned use entry as same start time as the unplanned use currently in progress. For example, the unplanned use detecting unit 132 extracts the unplanned use entries of “2013/1/29 from 10:00 to 11:30” and “2013/1/30 from 10:00 to 11:30” which has same start time as the unplanned use which is detected.

It is possible that the unplanned use detecting unit 132 extracts the unplanned use entry to be same or resemble as or to the state of the unplanned use which will occur after passing a predetermined time by narrowing down a target unplanned use entry to extract. Therefore, it is possible that the unplanned use detecting unit 132 judges whether or not the unplanned use will occur after passing a predetermined time based on the unplanned use entry which is a higher similarity as the state of the unplanned use, with more highly precise and estimates the duration time and the charge and discharge state of the unplanned use with a higher precise.

In addition, the scheduled time is exemplified in the case of 30 minutes in the specific example, but is not limited to this example. For example, when the scheduled time is 60 minutes, the unplanned use detecting unit 132 determines that the unplanned use has a possibility to occur at 60 minutes later when there exists the unplanned use entry in which the charge and discharge state in 60 minutes before the start time is same as the charge and discharge state (the electricity state AC in the specific example) of which the unplanned use detecting unit 132 acquired from 9:00 to 10:00.

As described above, in the charge and discharge control device 100 of the battery according to the third embodiment, the unplanned use detection unit detects first unplanned use which will occur after passing a predetermined time based on the unplanned use entry of the first battery of which the charge and discharge state after passing the predetermined time is same as the charge and discharge state of the first battery which is acquired at a predetermined time.

Therefore, it is possible that the charge and discharge control device 100 of the battery according to the third embodiment, determines whether the unplanned use will occur in former time based on the unplanned use history list IL. In addition, it is possible that the charge and discharge control device 100 of the battery estimates the duration time and the charge and discharge state of the unplanned use which will occur in the former time and corrects the charge and discharge control plan PL of some batteries beforehand. Or, it is possible that the charge and discharge control device 100 of the battery create the charge and discharge control plan PL of all batteries based on estimated information of the unplanned use which will occur in the former time. Therefore, it is possible that the charge and discharge control device 100 of the battery creates or corrects the charge and discharge control plan PL in consideration of the estimated information of the unplanned use before the unplanned use occurs. Therefore, it is possible that the charge and discharge control device 100 of the battery suppresses the frequency that the unplanned use produces and holds down the peak electricity more surely based on the charge and discharge control plan PL.

### Fourth Embodiment

In the fourth embodiment, the charge and discharge control device 100 of the battery, in consideration of paying attention to have a possibility to occur the unplanned use in response to the schedule of the user who uses the notebook PC 30, detects the unplanned use which will occur based on the schedule of the user and corrects the charge and discharge control plan PL. For example, the unplanned use is easy to occur in a scheduled time when going out such as business trips, because it is more likely to be in the electric discharge state BA in the notebook PC 30 as not available with an AC power. On the other hand, notebook PC 30 is hard to produce the unplanned use in a scheduled time when going out does not occur, because an AC power is available in the time. Thereby, it is possible that the charge and discharge control device 100 of the battery estimates the unplanned use which will occur in response to the schedule and corrects the charge and discharge control plan PL of the notebook PC 30 before the unplanned use occurs.

In the fourth embodiment, the hardware constitution and block configuration of the charge and discharge control device 100 of the battery are similar to that in the first embodiment (FIG. 5), and are omitted to explain. In addition, in the charge and discharge control device 100, the control device 130 (referring to FIG. 2) further has a schedule acquisition unit 138. The processes of the charge and discharge control device 100 of the battery according to the fourth embodiment will be explained.

(Processes of the Fourth Embodiment)

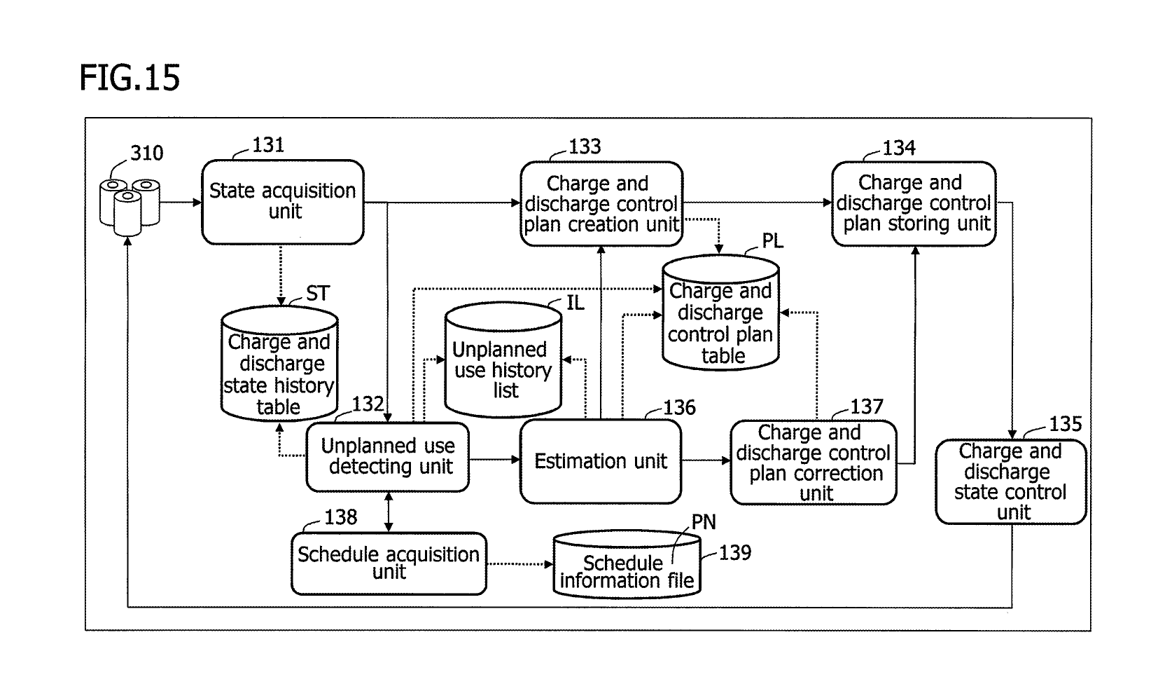

FIG. 15 is a diagram expressing a process flow of the charge and discharge control device 100 of the battery according to the fourth embodiment. The processes in the state acquisition unit 131, the plan creation unit 133, and the plan storing unit 134, the plan correction unit 137, and the state control unit 135 are similar to the explanation in FIG. 5 in the first embodiment. Therefore, the explanation of the processes of these units are omitted, but the processes of the schedule acquisition unit 138, the unplanned use detecting unit 132, and the estimation unit 136 will be explained as below.

In the fourth embodiment, the schedule acquisition unit 138 acquires schedule information PN of the user of the notebook PC 30. For example, the schedule acquisition unit 138 acquires the schedule information PN of the user from a database file 139 in a schedule management system. But the acquisition of the schedule is not limited to this example. For example, the charge and discharge control device 100 of the battery has a schedule management function, and the schedule acquisition unit 138 may acquire the schedule information PN from the schedule management function. Or, the schedule acquisition unit 138 may acquire the schedule information PN which is created by a schedule management application which operates on each notebook PC 30 and is stored in the notebook PC 30. Or, the schedule acquisition unit 138 may require the transmission of the schedule information PN to a schedule management system or the notebook PC 30. In addition, the schedule management system or the notebook PC 30 may periodically transmit the schedule information PN to the schedule acquisition unit 138 in the charge and discharge control device 100 of the battery.

In addition, the unplanned use detecting unit 132 according to the fourth embodiment selects the schedule in the period for the creation of the charge and discharge control plan PL among the schedule information PN which are acquired, and extracts the schedule history in which the identification information (for example, schedule name) is same as the identification information of the selected schedule information. And the unplanned use detecting unit 132 extracts the unplanned use entry which is corresponding to the extracted schedule history and is stored in the unplanned use history list IL. In addition, the estimation unit 136 estimates the duration time and the charge and discharge state of the unplanned use based on the unplanned use entry corresponding to the schedule history.

(Process Flow)

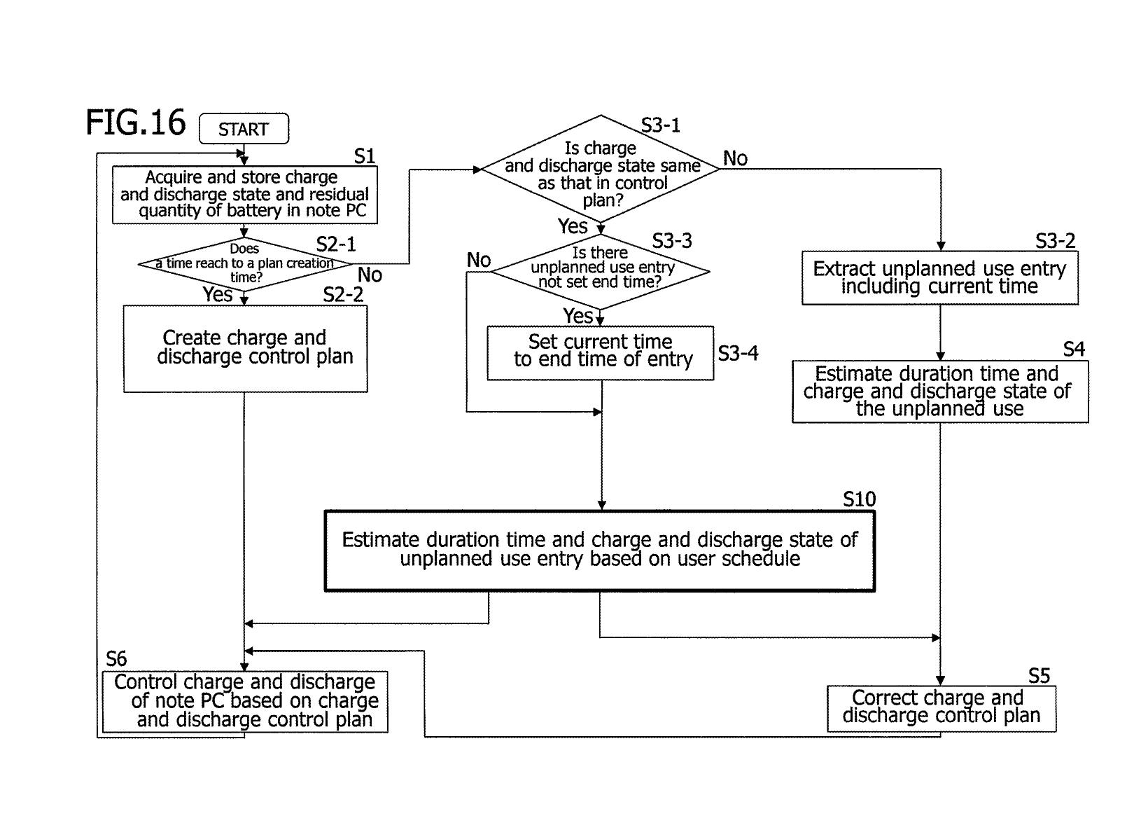

FIG. 16 is a diagram of a flow chart explaining the processes of the charge and discharge control device 100 of the battery according to the fourth embodiment. In FIG. 16, same steps as in FIG. 12 are marked by same symbol. That is, the process flow in FIG. 16 is same as the process flow in FIG. 12 except the step S9.

In other word, the charge and discharge control device 100 of the battery according to the fourth embodiment executes the step S10 in substitution for the step S9 in FIG. 12.

The unplanned use detecting unit 132 and the estimation unit 136 according to the fourth embodiment, when the unplanned use is not detected (YES/S3-1), detects the unplanned use which occurs corresponding to the schedule, and estimates the duration time and the charge and discharge state of the unplanned use which is detected (S10). And the plan correction unit 137 corrects the charge and discharge control plan PL of the notebook PC 30 which is detected the unplanned use so as to have the estimated charge and discharge state in the estimated duration time and corrects the charge and discharge control plan PL of the other notebook PC 30 for cancelling the influence on the consumption electricity by the unplanned use (S5).

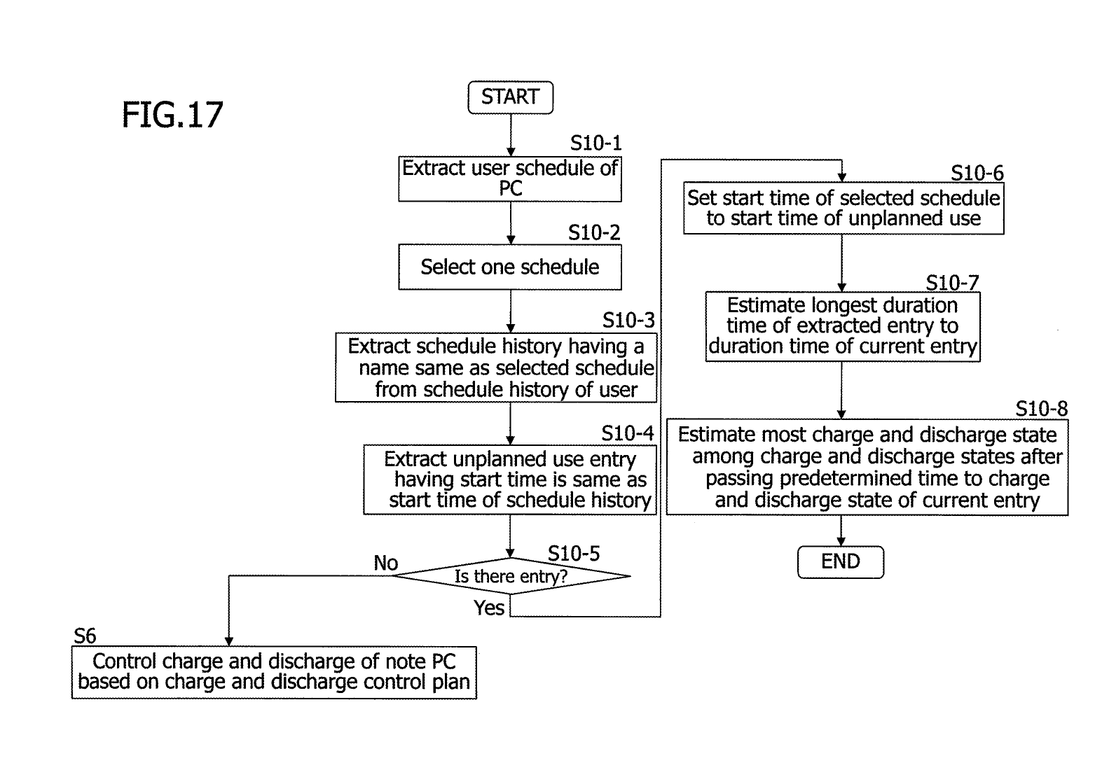

FIG. 17 is a diagram of flow chart explaining the process of the charge and discharge control device 100 of the battery according to the fourth embodiment in FIG. 16. The flow chart in FIG. 17 illustrates the processes in the step S10 in FIG. 16 in greater detail.

At first, the unplanned use detecting unit 132 extracts the schedule of the user of the target notebook PC 30 during the period (in this example, a day) which is already created the charge and discharge control plan PL, from the schedule information PN (S10-1). Then, the unplanned use detecting unit 132 selects one schedule among the schedules which are extracted (S10-2) and selects one or more schedule history of which the identification information (for example, schedule name) are same as that of the selected schedule from the schedule information PN (S10-3). The identification information is information indicating the schedule contents and classification. For example, the identification information is a schedule name. Therefore, the schedule histories which are extracted by the identification information are that the schedule is easy to cause as same state as the selected schedule.

And the unplanned use detecting unit 132 extracts the unplanned use entry of which the start time is same as that of one or more schedule history which are extracted from the unplanned use history list IL (S10-4). The unplanned use entries which are extracted are an unplanned use entry that is easy to cause same state as the selected schedule. The unplanned use detecting unit 132 judges whether or not the unplanned use entry occurs corresponding to the selected schedule based on the unplanned use entry which is extracted. As an example, the unplanned use detecting unit 132 determines that the unplanned use occurs in response to the schedule, when there is an extracted unplanned use entry (YES/S10-5). On the other hand, when there is not an extracted unplanned use entry (NO/S10-5), the unplanned use detecting unit 132 determines that the unplanned use does not occur in response to the schedule.

In addition, the unplanned use detecting unit 132 may determine that the unplanned use occurs in response to the schedule, only when the unplanned use entries more than the predetermined number are detected, or when the unplanned use entries corresponding to the schedule history of which is more than a predetermined ration (for example, more than 80%). Thereby, it is possible that the unplanned use detecting unit 132 determines whether or not unplanned use occurs with a high precise.

When determining that the unplanned use occurs based on the extracted unplanned use entry (YES/S10-5), the estimation unit 136 sets the schedule start time to the start time of the unplanned use (S10-6). And the estimation unit 136 estimates the duration time and the charge and discharge state of the unplanned use which will occur corresponding to the selected schedule based on the unplanned use entry which is extracted. The estimation unit 136, as same as the first embodiment, for example, estimates the duration time by considering when the unplanned use continues longest time based on the unplanned use entry which is extracted (S10-7). In addition, the estimation unit 136 may estimate the scheduled time band as the duration time. In addition, the estimation unit 136, as same as the first embodiment, acquire each of the charge and discharge states from the start time until the end time, from the unplanned use entries which are extracted, and estimates the charge and discharge state where there is the most among the charge and discharge states after passing the predetermined time from the start time, as the charge and discharge state of the unplanned use which occurs in response to the schedule (S10-8).

And the plan correction unit 137 corrects the charge and discharge control plan PL of the notebook PC 30, in which the unplanned use occurring corresponding to the schedule is detected, so as to have the estimated charge and discharge state in the estimated duration time. Further, the plan correction unit 137 corrects the charge and discharge control plan PL of the other notebook PC 30, so as to cancel the increase and decrease of the consumption electricity by the correction of the charge and discharge control plan PL of the notebook PC 30 which is detected the unplanned use (S5).

In addition, the plan correction unit 137, as same as the first embodiment, may not correct the charge and discharge control plan PL in a case that the peak electricity when the unplanned use occurs as estimation in the charge and discharge control plan PL does not exceed the peak electricity when the charge and discharge control plan PL is not corrected. It is possible that the plan correction unit 137 reduce the load because the re-creation of the charge and discharge control plan PL becomes needless.

The processes of the charge and discharge control device 100 of the battery according to the fourth embodiment that were illustrated by FIG. 16 and FIG. 17, will be explained based on a specific example.

(Specific Example)

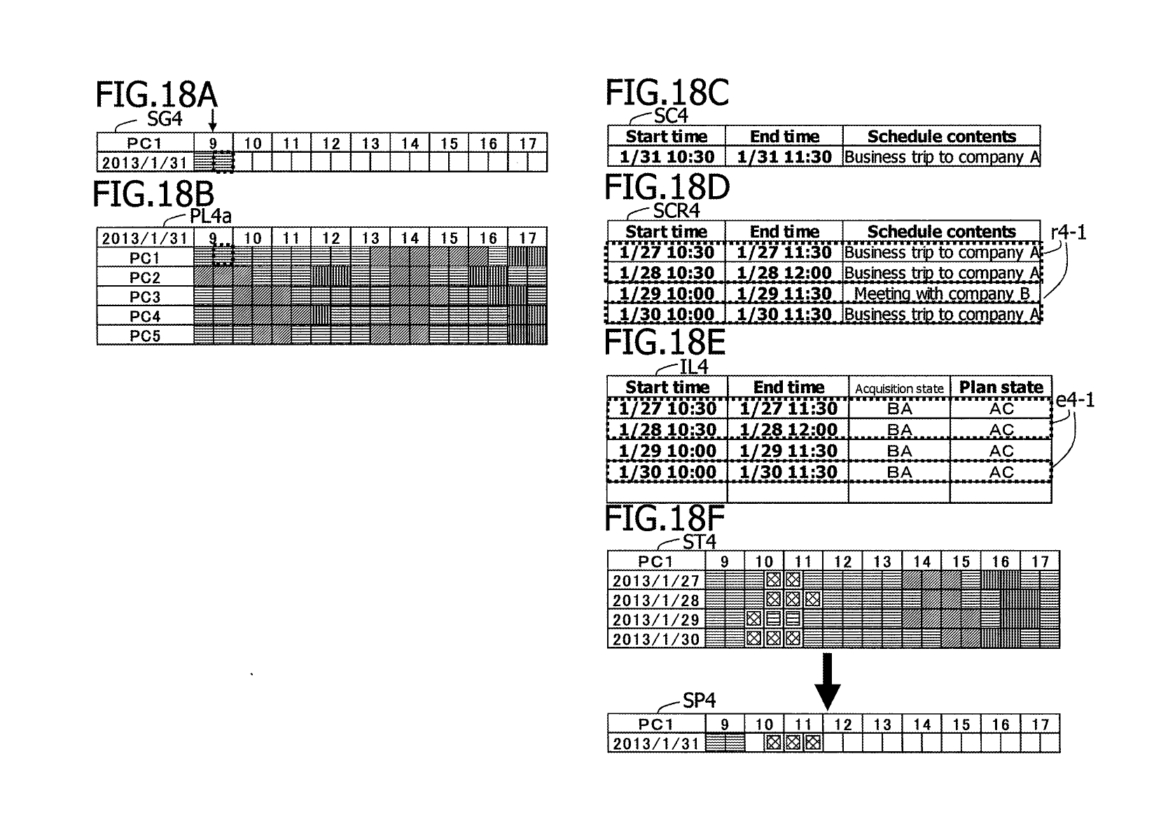

FIG. 18A, FIG. 18B, FIG. 18C, FIG. 18D, FIG. 18E, and FIG. 18F are diagrams explaining a specific example of the process of the charge and discharge control device 100 of the battery according to the fourth embodiment. In FIG. 18A to FIG. 18F, same portions as FIG. 4, FIG. 8A, FIG. 8B and FIG. 14A, FIG. 14B are illustrated by same marks. In the example, a case, in which the charge and discharge control device 100 estimates the unplanned use of the PC1 at the time 2013/1/31 09:30, will be explained. FIG. 18A illustrates an examples of the charge and discharge state SG4 of the PC1 which is acquired, and FIG. 18B illustrates an example of the first charge and discharge control plan PL4a. FIG. 18C illustrates an example of the schedule list SC4 of the user 1 which utilizes the PC1 at 2013/1/31, FIG. 18D illustrates an example of the schedule history SCR4 of the user 1, FIG. 18E illustrates an example of the unplanned use history list IL4 of the PC1, and FIG. 18F illustrates an example of the charge and discharge state history table ST4 of the PC1 and the estimation information SP4.

According to an example in FIG. 18A and FIG. 18B, the charge and discharge state SG4 of the PC1 indicates the electricity state AC of the PC1 which is acquired at 9:30 (indicated by a mark “arrow” in FIG. 18A). While, the charge and discharge state at 9:30 in the charge and discharge control plan PL4a of the PC1 also indicates the electricity state AC. That is, at acquired time 9:30, both charge and discharge states are same. Therefore, the unplanned use detecting unit 132 does not detect the unplanned use (YES/S3-1). And the unplanned use detecting unit 132 extracts the schedule list SC4 of the user (in the example, user 1) which utilizes the target notebook PC 30 (in the example, PC1) during the period in which the charge and discharge control plan PL is already created (in the example, 2013/1/31), from the schedule information PN (S10-1). Then, the unplanned use detecting unit 132 selects the schedule “from 10:30 to 12:00: a business trip to A company” from the schedule list SC4 of the user at 2013/1/31, for example (S10-2). Further, in the schedule history SCR4 of the user 1 in FIG. 18D, three schedules of which the name is “business trip to A company” exist. Therefore, the unplanned use detecting unit 132 extracts three schedule histories r4-1 of “2013/1/27 10;30-11:30”, “2013/1/28 10:30-12:00” and “2013/1/30 10:00-11:30” from the schedule history SCR4 of the user 1 (S10-3).

Then, the unplanned use detecting unit 132 extracts the unplanned use entries e4-1 of “2013/1/27 from 10:30 to 11:30”, “2013/1/28 from 10:30 to 12:00”, and “2013/1/30 from 10:00 to 11:30” which have same start time as three schedule histories r4-1 which are extracted, from the unplanned use history list IL4. In the example, the unplanned use detecting unit 132 determines that the unplanned use will occur in response to the schedule because the unplanned use entry e4-1 to extract out exists (YES/S10-5). The estimation unit 136 sets the selected schedule start time “10:30” to the start time of the unplanned use (S10-6).

Then, the estimation unit 136 estimates longest duration time 1.5 hours among each of duration times in the unplanned use entries e4-1 which are extracted to the duration time of the unplanned use (S10-7). Therefore, the end time of the unplanned use occurring from 10:30 becomes 2013/1/31 12:00. In addition, the estimation unit 136 acquires each of the charge and discharge states in the duration time of the unplanned entry e4-1 which is extracted, by referring to the charge and discharge state history table ST4 in FIG. 18F, and estimates, as the charge and discharge state of the unplanned use, the charge and discharge state BA where there is the most among the charge and discharge states (S10-8). Therefore, the estimation unit 136 estimates that the PC1 becomes to the electric discharge state BA during 2013/1/31 from 10:30 to 12:00, as depicted by the estimated information SP4.

And the plan correction unit 137 corrects the charge and discharge state in 2013/1/31 from 10:30 to 12:00 of the charge and discharge control plan PL of the PC1 in the electric discharge state BA and corrects the charge and discharge control plan PL of different notebook PC 30 to cancel the increase and decrease of the consumption electricity by the correction of PC1, as same as the first embodiment (S5).

In addition, as same as the first embodiment, the unplanned use detecting unit 132 may limit the unplanned use entry e4-1 to extract, into the unplanned use entry in the fixed period, or may limit the unplanned use entry e4-1 into the unplanned use entry same day of week and the time band (the morning, the afternoon) as the unplanned use which is selected. Or, the unplanned use detecting unit 132 may extract the unplanned use entry as same start time as the unplanned use currently in progress. For example, the unplanned use detecting unit 132 extracts the unplanned use entries of “2013/1/27 from 10:30 to 11:30” and “2013/1/28 from 10:30 to 12:00” which has same start time as the unplanned use which is selected. In addition, the unplanned use detecting unit 132 may extract only unplanned use entry which has same end time in addition to the selected schedule and the start time. For example, in a specific example, the unplanned use detecting unit 132 extracts only unplanned use entry “2013/1/28 from 10:30 to 12:00” of which the start time and the end time are same as that of the selected schedule.

It is possible that the unplanned use detecting unit 132 extracts the unplanned use entry which has same or resemble state as or with the unplanned use which will occur in response to the schedule by narrowing down a target unplanned use entry to extract. Therefore, it is possible that the unplanned use detecting unit 132 detects the schedule which will occur the unplanned use based on the unplanned use entry with more similar state with a highly precise and estimates the duration time and the charge and discharge state of the unplanned use with a higher precise.

As described above, the charge and discharge control device 100 of the battery according to fourth embodiment further has a schedule acquisition unit which acquires the user schedule of the battery. And the unplanned use detecting unit in the charge and discharge control device 100 of the battery extracts one or more second schedule histories in which the identification information is same as that of the first schedule and detects the first unplanned use occurring in response to the first schedule based on the unplanned use entry corresponding to the history of the second schedule which is extracted.

Therefore, it is possible that the charge and discharge control device 100 of the battery according to the fourth embodiment, by paying attention to occur the unplanned use in response to the schedule, judges whether the unplanned use occurs in response to the schedule based on the schedule history. In addition, it is possible that the charge and discharge control device 100 of the battery corrects the charge and discharge control plan PL of some batteries beforehand by estimating the duration time and the charge and discharge state of the unplanned use which will occur in response to the schedule. Therefore, it is possible that the charge and discharge control device 100 of the battery raises the realization of the charge and discharge control plan PL and suppress the peak electricity without disagreeing with the original introduction purpose of the battery.

In addition, the charge and discharge control device 100 of the battery does not correct the charge and discharge control plan PL about the time when determined that the unplanned use does not occur in response to the schedule. Therefore, it is possible that the charge and discharge control device 100 of the battery reduces load of the processing by omitting the correction of the charge and discharge control plan PL.

In addition, in the fourth embodiment, the plan correction unit in the charge and discharge control device 100 of the battery, as same as the first embodiment, may not correct the charge and discharge control plan PL in a case of occurring the unplanned use according to the estimation in the charge and discharge control plan PL, does not exceed the peak electricity when the charge and discharge control plan PL is not corrected. That is, the charge and discharge control device 100 of the battery may not correct the charge and discharge control plan PL even when the unplanned use is detected, when the peak electricity is not influenced. It is possible that the plan correction unit 137 reduce the load by omitting the correction of the charge and discharge control plan PL.

In addition, The charge and discharge control device 100 of the battery may estimate the duration time and the charge and discharge state which will occur in response to the schedule beforehand and may create the charge and discharge control plan PL of all notebook PCs 30. Thereby, it is possible that the charge and discharge control device 100 of the battery create the charge and discharge control plan PL which is considered the unplanned use which will occur in response to the schedule beforehand.

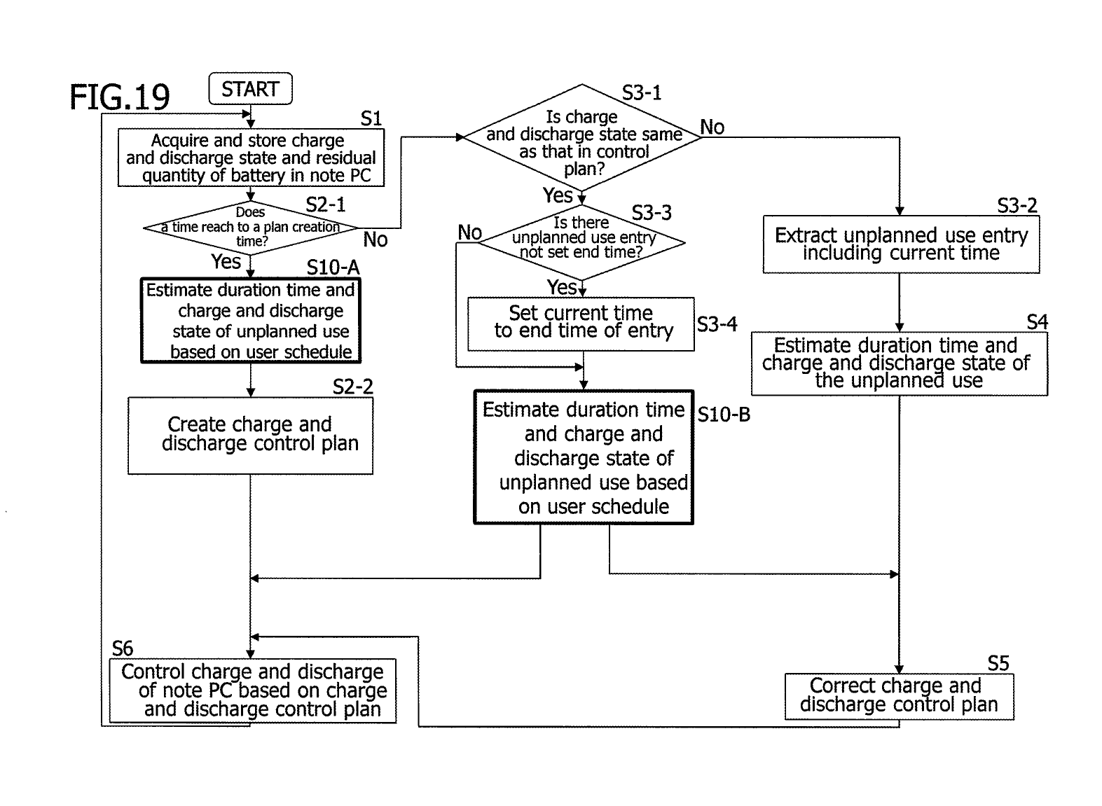

FIG. 19 is a diagram of a flow chart explaining processes of the charge and discharge control device 100 of the battery according to an modification of the fourth embodiment. In FIG. 19, same steps as in FIG. 16 are marked by same symbol. That is, the process flow in FIG. 19 is added the step S10-A to the process flow in FIG. 16. In the example of FIG. 19, the plan creation unit 133, when a time reaches to the creation time of the charge and discharge control plan PL (YES/S2-1), determines whether or not the unplanned use will occur in response to the schedule in the period for the creation of the charge and discharge control plan PL and estimates the duration time and the charge and discharge state of the unplanned use which will occur (S10-A). The processes in the step S10-A are just mentioned above. And the plan creation unit 133 has estimated information of the unplanned use which has been detected, and creates the charge and discharge control plan PL so that the peak electricity becomes small in consideration of an electricity demand prediction, specifications of each notebook PC 30, current charge and discharge state and battery residual quantity (S2-2).

In other words, the charge and discharge control device 100 of the battery estimates the duration and the charge and discharge state of the unplanned use which will occur in response to the schedule before creating of the charge and discharge control plan PL beforehand and creates the charge and discharge control plan PL which is considered the charge and discharge state which is estimated. It is possible that the charge and discharge control device 100 of the battery raise the realization of the charge and discharge control plan PL and suppress the peak electricity more surely.

(Modification Example 1 of the Fourth Embodiment)

In addition, the notebook PC 30 becomes to the electricity state AC even when the electric discharge state BA is appointed in the charge and discharge control plan PL when there are few battery residual quantities. Similarly, the notebook PC 30 becomes to the electricity state AC even when the charge state CH is appointed in the charge and discharge control plan PL when the battery residual quantity is full. In other words, the unplanned use may produce due to the battery residual quantity even when the notebook PC 30 is able to control according to the charge and discharge control plan PL without a problem in a battery residual quantity. Therefore, when the unplanned use may occur due to the battery residual quantity, not due the plan, the charge and discharge control device 100 of the battery may regard as not occurred the unplanned use.

In other words, the unplanned use detection unit in the charge and discharge control device 100 of the battery does not detect the first unplanned use when the charge and discharge state in the duration of the unplanned use entry which is extracted is the electricity state AC. In other words, the charge and discharge control device 100, when the charge and discharge state in the time of the schedule history, in which the identification information (for example, schedule name) is same as the target schedule, is the electricity state AC, estimates that the notebook PC is not controllable according the plan due to the battery residual quantity and regards that the unplanned use does not occur, even when the acquired charge and discharge state is different from the charge and discharge state appointed in the charge and discharge control plan PL. Thereby, it is possible that the charge and discharge control device 100 of the battery determines whether or not the unplanned use occurs according to the schedule in more precise. Therefore, it is possible that the charge and discharge control device 100 of the battery creates the charge and discharge control plan PL flexibly when determining that the unplanned use does not occur, and reduces a load of processing because the correction becomes needless.

(Modification Example 2 of the Fourth Embodiment)

In addition, the notebook PC 30 becomes the electric discharge state BA in the environment without an AC power even when either one of the charge and discharge state is appointed in the charge and discharge control plan PL. In other words, in the time band in which the notebook PC 30 becomes the discharge state BA corresponding to the schedule, when the discharge state BA is appointed in the charge and discharge control plan PL, the unplanned use is not detected and the unplanned use entry corresponding to the schedule is not made. Therefore, in the charge and discharge control plan PL, the charge and discharge state except the electric discharge state BA is appointed in the same schedule time of the next time, and the unplanned use may occur due to the appointment. Therefore, the charge and discharge control device 100 of the battery detects the unplanned use when all of the charge and discharge states in the time band of the schedule history are the discharge states BA, even when the unplanned use corresponding to the schedule history of which the identification information is same as that of the selected schedule.

In other words, the unplanned use detection unit in the charge and discharge control device 100 of the battery detects the first unplanned use when all of the charge and discharge states in the time band of the second schedule history even when the unplanned use entry is not extracted is the electricity discharge state BA. And, the estimation unit estimates the charge and discharge state of the first unplanned use to the electricity discharge state. Thereby, it is possible that the charge and discharge control device 100 of the battery designates the electricity discharge state BA in the schedules time band which has a possibility to become the electricity discharge state beforehand. Accordingly, it is possible to realize the charge and discharge control plan PL and suppress the peak electricity.

(Modification Example 3 of the Fourth Embodiment)

In addition, when the unplanned use does not occur even when either one of the charge and discharge state is designated in a planned time band, the planned time band is indicted as the time band in which the notebook PC 30 is controllable according to the plan. Therefore, when the charge and discharge state during the time band of the planned history, which has same identification information as the selected plan, includes all kinds of the charge and discharge state (electricity discharge state BA, the electricity state AC, and electricity charge state CH) and the unplanned use entry corresponding to the planned history is not extracted, the charge and discharge control device 100 of the battery may regard the selected planned time band as the time band in which the notebook PC 30 is controllable according to the plan.

Specially, the charge and discharge control device 100 of the battery, when all kinds of the charge and discharge state during the planned time band, which has same identification information as the selected plan, are designated and the unplanned use entry corresponding to the planned history is not extracted, determines that unplanned use does not occur in response to the selected plan.

In other words, the unplanned use detection unit in the charge and discharge control device 100 of the battery does not detect the first unplanned use when the unplanned use entry is not detected and the charge and discharge state includes all kinds of the charge and discharge state during the time band of the second history. Therefore, it is possible that the charge and discharge control device 100 of the battery determines whether or not the unplanned use will occur in response to the plan with a more precise. Accordingly, it is possible that the charge and discharge control device 100 of the battery flexibly creates the charge and discharge control plan PL when determining that the unplanned use does not occur, and reduce load of the processing because the correction becomes needless.

(Modification Example 4 of the Fourth Embodiment)

Furthermore, the charge and discharge control device 100 of the battery may inspect whether or not the planned time band is the time band in which the notebook PC 30 is controllable according to the plan. That is, when it is controllable in the planned time band according to the plan, the unplanned use does not occur in the planned time band, even though the charge and discharge state except the charge and discharge state which is estimated designated in the planned time band in the charge and discharge control plan PL.

For example, the charge and discharge control device 100 of the battery designates the charge and discharge state except the charge and discharge state which is estimated in the planned time band, so as not to exceed the peak electricity when the charge and discharge control plan PL of the notebook PC 30, which is detected the unplanned use, is corrected so as to have the charge and discharge state which is estimated in the planned time band. Afterward, the charge and discharge control device 100 of the battery, when the unplanned use does not occur in the planned time, regards that the notebook PC 30 is controllable as scheduled, and deletes the unplanned use entry corresponding to the unplanned use.

In other words, the control plan correction unit in charge and discharge control device 100 of the battery corrects the charge and discharge control plan PL of the first battery so as to have the charge and discharge state except the estimated charge and discharge state in the first scheduled time band, so as not to exceed the peak electricity when the charge and discharge control plan PL is corrected so as to have the charge and discharge state which is estimated in the duration time of the first unplanned use which is estimated. And the unplanned use detecting unit, when not detecting the unplanned use in the first planned time, deletes the unplanned use entry corresponding to the first unplanned use, and does not extract the unplanned use of the second schedule when extracting that the identification information of the first schedule is same as the identification of the second schedule.

Thereby, it is possible that the charge and discharge control device 100 of the battery determines whether or not the unplanned use will occur in response to the schedule with more highly precise. Therefore, it is possible that the charge and discharge control device 100 of the battery flexibly creates the charge and discharge control plan PL when determining that the unplanned use does not occur, and reduces load of the processing because the correction becomes needless.

### Fifth Embodiment

In a fifth embodiment, the charge and discharge control device 100 of the battery estimates the charge and discharge state in the scheduled time based on the charge and discharge state in the scheduled history, by paying attention that the schedules which have same identification information are easy to be in same state, and creates the charge and discharge control plan PL having the charge and discharge states which are estimated. Thereby, it is possible that the charge and discharge control device 100 of the battery raises the realization of the charge and discharge control plan PL and suppresses the peak electricity surely without disagreeing with the original introduction purpose of the battery.

In the fifth embodiment, the hardware constitution and block configuration of the charge and discharge control device 100 of the battery are similar to that in the first embodiment (FIG. 5), and are omitted to explain. In addition, in the charge and discharge control device 100, the control device 130 (referring to FIG. 2) further has not the unplanned use detecting unit 132 and the plan correction unit 137, but has the schedule acquisition unit 138. The processes of the charge and discharge control device 100 of the battery according to the fifth embodiment will be explained.

(Processes of the Fifth Embodiment)

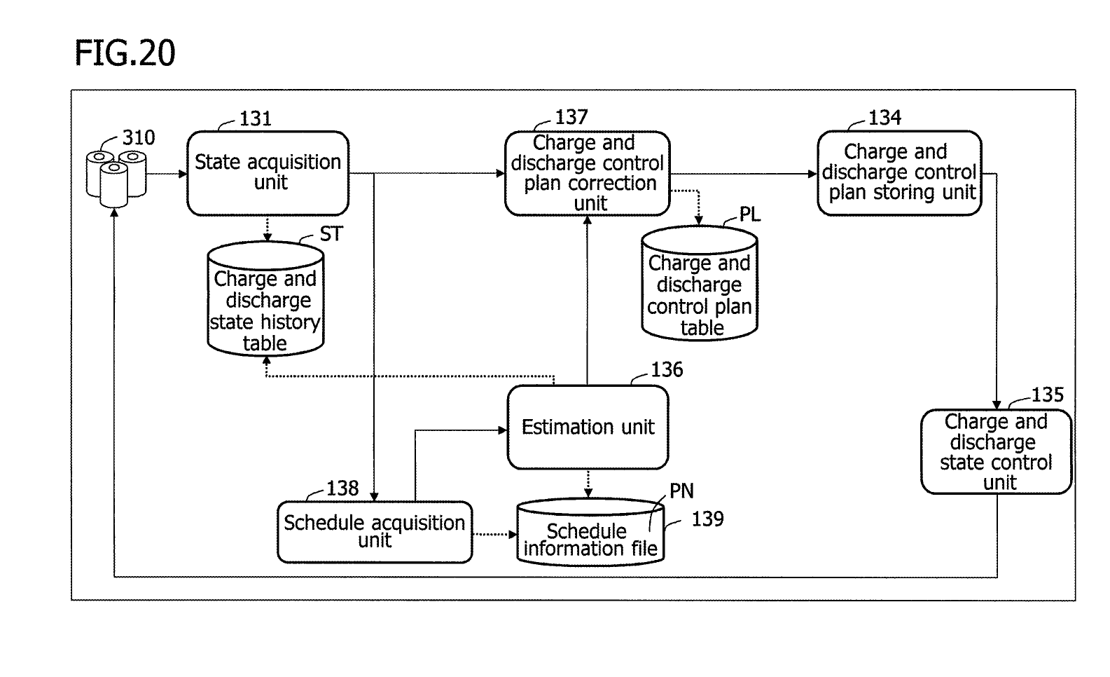

FIG. 20 is a diagram expressing a process flow of the charge and discharge control device 100 of the battery according to the fifth embodiment. In FIG. 20, the processes in the state acquisition unit 131, the plan creation unit 133, the plan storing unit 134, the state control unit 135 and the schedule acquisition unit 138 are similar to the explanation in FIG. 15 in the fourth embodiment. Therefore, the explanations of the processes of these units are omitted, but the processes of the estimation unit 136 will be explained as below. In the fifth embodiment, the estimation unit 136 refers to the schedule information file PN, selects the schedule in the period for the creation of the charge and discharge control plan PL and extracts the schedule history of which the identification information is same as that of the selected schedule. And the estimation unit 136, with reference to the charge and discharge state history table ST, acquires the charge and discharge state in the time of the schedule history which is extracted, and estimates the charge and discharge state in the time of the selected schedule.

(Process Flow of the Fifth Embodiment)

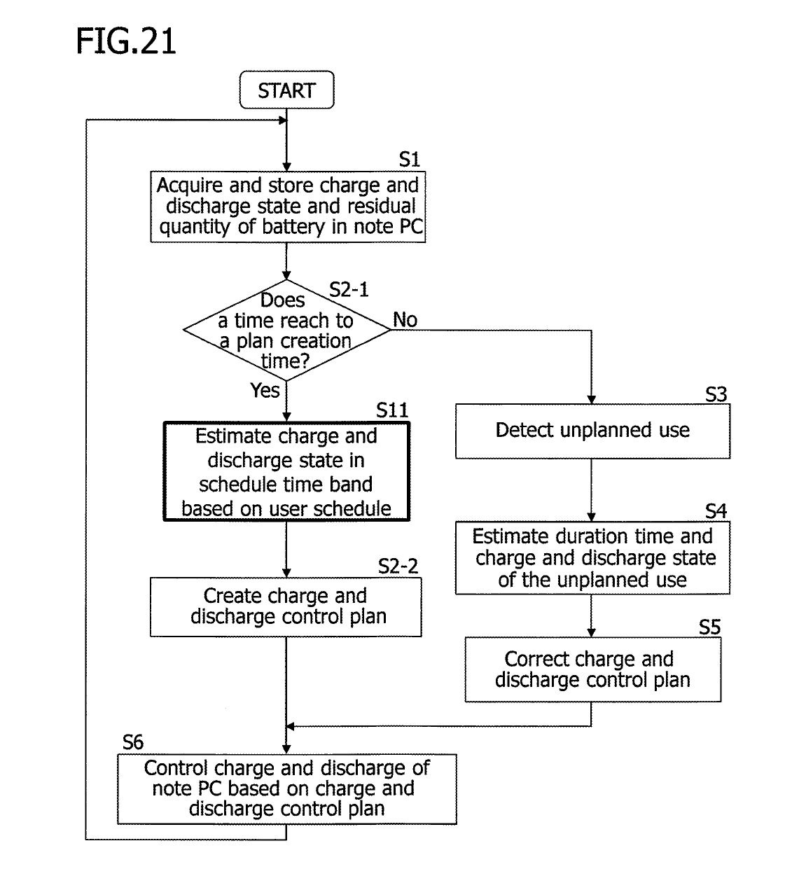

FIG. 21 is a diagram of flow chart explaining a flow of the processes of the charge and discharge control device 100 of the battery according to the fifth embodiment. In FIG. 21, same steps as in FIG. 6 and FIG. 7 are marked by same symbol. That is, the processes in the step S1—the step S6 are similar to that in the first embodiment (FIG. 6 and FIG. 7). In the fifth embodiment, the plan acquisition unit 138, when a time reaches to the creation time of the charge and discharge control plan PL (YES/S2-1), acquires the schedule information PN of the user of the notebook PC 30. The estimation unit 136 estimates the charge and discharge state in the planned time based on the schedule information PN (S11). Then, the plan creation unit 133 creates the charge and discharge control plan PL having the estimated the charge and discharge state in the scheduled time, so that the peak electricity becomes small in consideration of an electricity demand prediction, specifications of each notebook PC 30, the current charge and discharge state and the battery residual quantity (S2-2). And the state control unit 135 controls the battery of each PC based on the charge and discharge control plan PL which is created (S6). When a time does not reach at the creation time of the charge and discharge control plan PL (NO/S2-1), the process is similar to that in the first embodiment.

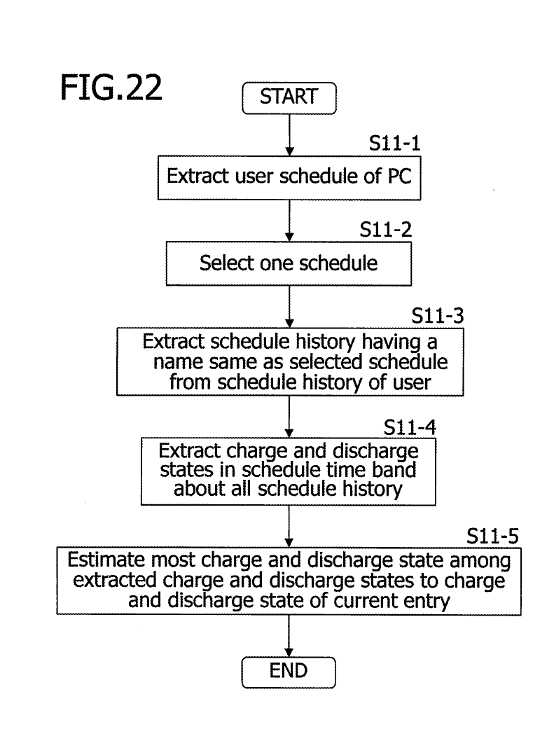

FIG. 22 is a diagram of a flow chart explaining processes of the charge and discharge control device 100 of the battery according to the fifth embodiment in great detail. A flow chart in FIG. 22 illustrates the processes in the step S11 in FIG. 21, in great detail.

In FIG. 22, the estimation unit, as same as the fourth embodiment, extracts the schedule of the user of the target notebook PC 30 during the period (in this example, a present day) that the charge and discharge control plan PL has been created from the schedule information PN (S11-1). Then, the estimation unit 136 selects one schedule among the schedules which are extracted (S11-2) and extracts one or more schedule histories which have same identification information as that of the selected schedule from the schedule information PN (S11-3). The identification information is information indicating the schedule contents or schedule classification, and, for example, is a schedule name. The schedule history which are extracted is easy to produce the charge and discharge state which is the same as the selected schedule.

Then, the estimation unit 136 extracts the charge and discharge state in the time of the schedule history with reference to the charge and discharge state history table ST about all of the schedule histories which are extracted (S11-4). And the estimation unit 136 estimates the charge and discharge state which is a most charge and discharge state among the charge and discharge states which are extracted, to the charge and discharge state which will occur in the scheduled time (S11-5). And the plan creation unit 133 creates the charge and discharge control plan PL having the estimated charge and discharge state in the schedule time, so that the peak electricity becomes small in consideration of an electricity demand prediction, specifications of each notebook PC 30, current charge and discharge state and battery residual quantity (S2-2). In addition, the plan creation unit 133 appoints the charge and discharge state in the time except the schedule so as to control by the charge and discharge state which is estimated in the schedule time.

In addition, in the creation processing (S2-2) of the charge and discharge control plan PL, the plan creation unit 133 may not appoint the charge and discharge state which is estimated in the schedule time, when the peak electricity does not increase when the charge and discharge state, which is estimated in the schedule time, occurred in the charge and discharge control plan PL which is created with disregard to the scheduled charge and discharge state which is estimated. Thereby, it is possible that the charge and discharge control plan creation unit 133 flexibly creates the charge and discharge control plan PL because the plan creation unit 133 does not have to appoint the charge and discharge state which is estimated in the schedule time.

In addition, because both of the electricity state AC and charge state CH are the charge and discharge state in an environment of which the AC power is available, the schedule time, in which the estimated charge and discharge state is the electricity state AC or the charge state CH, may be estimated that the AC power is available. Therefore, the charge and discharge control device 100 of the battery may appoint one of the electricity state AC or the charge state CH in the schedule time of the charge and discharge control plan PL, in case without a problem in the peak electricity, when estimating the charge and discharge state in the schedule time the electricity state AC or the charge state CH. Thereby, it is possible that the charge and discharge control device 100 of the battery creates controllable charge and discharge control plan PL as scheduled with a more flexibly.

Specially, the plan creation unit 133 creates the charge and discharge control plan PL having the charge and discharge state which one of the electricity state AC and the charge state CH in the schedule time which is estimated as which one of the electricity state AC and the charge state CH, so that the peak electricity becomes small in consideration of an electricity demand prediction, specifications of each notebook PC 30, current charge and discharge state and battery residual quantity. In addition, the charge and discharge control device 100 of the battery may treat as a common charge and discharge state (for example, electricity feeding state AC/CH). The state acquisition unit 131 acquires the charge and discharge state as the electricity feeding state AC/CH when the charge and discharge state of the notebook PC is either one of the electricity state AC and the charge state CH. In addition, for example, the plan creation unit 133 estimates the charge and discharge state in the schedule time as the electricity feeding state AC/CH.

In other words, the plan creation unit in the charge and discharge control device 100 of the battery creates the charge and discharge control plan PL having the discharge state BA in the first schedule (selected schedule) time when the estimated charge and discharge state is the discharge state BA, or the either one of the electricity state AC and the charge state CH in the first schedule time when the estimated charge and discharge state is the charge and discharge state (the electricity state AC or the charge state CH) except the discharge state BA. Thereby, because the charge and discharge control device 100 of the battery does not have to distinguish the electricity state AC or the charge state CH, it is possible to create the charge and discharge control plan PL more flexibly. In addition, it is possible that the charge and discharge control device 100 of the battery estimates the charge and discharge state in the schedule time with more highly precise, and creates the charge and discharge control plan PL which controls the notebook PC 30 according to the schedule, because the electricity state AC and the charge state CH are as common charge and discharge state.

On the other hand, the electric discharge state BA is the charge and discharge state in the environment that the AC power is not available, and the notebook PC 30 becomes to the electric discharge state BA. In contrast, the charge and discharge state could be both charge and discharge state when the AC power is available. Therefore, for example, the charge and discharge control device 100 of the battery creates the charge and discharge control plan PL having either one of both charge and discharge states in the scheduled time except the time in which the estimated charge and discharge state is the discharge state BA, so that the peak electricity becomes small.

In other words, the plan creation unit in the charge and discharge control device 100 of the battery creates the charge and discharge control plan PL having the discharge state BA in the first schedule (selected schedule) time when the estimated charge and discharge state is the discharge state BA, or having the either one of the electricity state AC and the charge state CH in the first schedule time when the estimated charge and discharge state is the charge and discharge state (the electricity state AC or the charge state CH) except the discharge state BA. Thereby, because the charge and discharge control device 100 of the battery designates the discharge state BA in only time band when the estimated charge and discharge state is the discharge state BA, it is possible to create the charge and discharge control plan PL more flexibly. In addition, it is possible that the charge and discharge control device 100 of the battery estimates the charge and discharge state in the schedule time with more highly precise, and creates the charge and discharge control plan PL which controls the notebook PC 30 according to the schedule, because the electricity state AC and the charge state CH are estimated not to distinguish from each other.

The processes of the charge and discharge control device 100 of the battery according to the fourth embodiment that were illustrated by FIG. 21 and FIG. 22, will be explained based on a specific example.

(Specific Example)

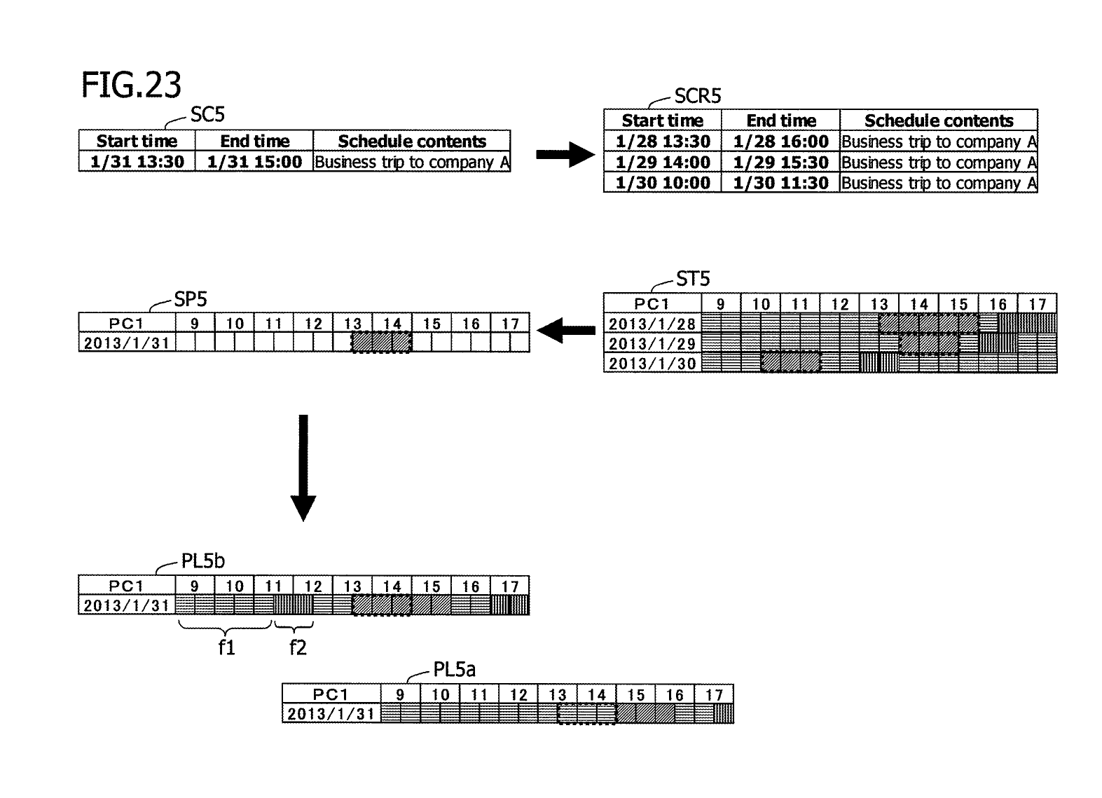

FIG. 23 is a diagram explaining a specific example of the process of the charge and discharge control device 100 of the battery according to the fifth embodiment. In FIG. 23, same portions as FIG. 4, FIG. 8A, FIG. 8B and FIG. 14A, FIG. 14B and FIG. 18A˜FIG. 18F are illustrated by same marks. In the example, a case, in which the charge and discharge control device 100 creates the charge and discharge control plan PL at the time 2013/1/31, will be explained. FIG. 23 illustrates examples of the schedule list SC5 of the user 1 which utilizes the PC1 at 2013/1/31, the schedule history SCR5 of the user 1, the charge and discharge state history table ST5 of the PC1, the estimation information SP5, and the charge and discharge control plans PL 5a and PL5b. The charge and discharge control plan PL5b is a charge and discharge control plan which is created in considering the charge and discharge state in the estimated schedule time, and the charge and discharge control plan PL5a is a charge and discharge control plan which is created without considering the charge and discharge state in the estimated schedule time.

When a time reaches at the creation of the charge and discharge control plan PL (YES/S2-1), the estimation unit 136 extracts the schedule list SC5 of the user (in the example, User1) of the target notebook PC 30 (in the example, PC1) in a period for the creation of the charge and discharge control plan PL5b from the schedule information PN (S11-1). Successively the estimation unit 136 selects a schedule “from 13:30 to 15:00: a business trip to company A” from the schedule list SC5 of 2013/1/31 of the User1 in FIG. 23, for example (S11-2). In addition, in the schedule history SCR5 of the User1 in FIG. 23, there exists three schedules named “the business trip to company A”. Therefore, estimation unit 136 extracts three schedule histories “2013/1/28 from 13:30 to 16:00”, “2013/1/29 from 14:00 to 15:30”, and “2013/1/30 from 10:00 to 11:30” from the schedule history SCR 5 of the User1 (S11-3). In the charge and discharge state history table ST5 in FIG. 23, all charge and discharge states of the schedule history which are extracted are the electric discharge state BA (S11-4). Therefore, the estimation unit 136, as indicated by the estimated information SP5 in FIG. 23, estimates that the charge and discharge state for 2013/1/31 from 13:30 to 15:00 of the PC1 is the electric discharge state BA (S11-5).

And the plan creation unit 133 appoints the estimated discharge state BA from 13:30 to 15:00 of 2013/1/31 of the PC1 and creates the charge and discharge control plan PL5b which appoints the electric discharge state BA from 15:00 to 16:30 so that the peak electricity becomes small (S2-2). In addition, when the battery residual quantity of the PC1 is few from 13:30 to 15:00, the battery drive is difficult. Therefore, the plan creation unit 133 appoints the charge and discharge state except the discharge state BA as the charge and discharge state from 9:00 to 11:30 (as indicated by “f1” in the charge and discharge control plan PL5b in FIG. 23), and appoints the charge state CH to from 11:30 to 12:30 (as indicated by “f2” in the charge and discharge control plan PL5b in FIG. 23) with a few electricity demand predictions. And the plan creation unit 133 creates the charge and discharge control plan PL5b to be able to maintain the battery residual quantity that is enough at the time 13:30.

In contrast, according to the charge and discharge control plan PL5a in FIG. 23, the electricity state AC is appointed from 13:30 to 15:00 and the electric discharge state BA is appointed from 15:00 to 16:30. However, the PC1 lacks the battery residual quantity in the time of from 15:00 to 16:30 because becoming to the electric discharge state BA in the time of from 13:30 to 15:00 by a business trip to company A. Accordingly, the charge and discharge state becomes to the electricity state AC from 15:00 to 16:30. As a result, consumption electricity increases from 15:00 to 16:30, and the peak electricity increases.

In addition, the estimation unit 136, as same as the first embodiment, may limit the schedule history of the target to extract to the schedule history in the fixed period of time, and may limit it to the schedule history in which a day or a time (the morning, the afternoon) is same as the selected schedule history in addition to the name. Or, the estimation unit 136 may extract only the schedule history in which the start time is same as the selected schedule in addition to a name. For example, the estimation unit 136 further extracts only schedule history “2013/1/28 from 13:30 to 16:00” in which the start time is same as the selected schedule (S11-3). In addition, the estimation unit 136 may extract only the schedule history in which the end time is same as the selected schedule in addition to the name.

In addition, the charge and discharge state of the schedule time that the estimation unit 136 estimates may not be a single charge and discharge state. For example, the estimation unit 136 may estimate the charge and discharge state for every constant unit hour from the start time in the schedule time. By estimating the charge and discharge state for every constant unit hour, it is possible that the estimated part 136 estimates the schedule charge and discharge state in a case of making arrangements in a meeting room without the AC power in front half, and of working in the place with the AC power in the latter half, with a high precise.

As described above, the charge and discharge control device 100 of the battery according to the fifth embodiment, has the charge and discharge state acquisition unit which acquires the charge and discharge state including the electric discharge state BA, the electricity state AC, and the charge state CH of the battery and the schedule acquisition unit which acquires the schedule of the user of the first battery. In addition, the charge and discharge control device 100 of the battery has the estimation unit which estimates the charge and discharge state in the first schedule time band of the battery based on the charge and discharge state in one or more second schedule time band in which the identification information is same as the first schedule, and the control plan creation unit which creates the charge and discharge control plan PL so that the peak electricity becomes small. And the control plan creation unit creates the charge and discharge control plan PL to have the charge and discharge state which is estimated in the first schedule time.

Thereby, it is possible that the charge and discharge control device 100 of the battery estimates the planned charge and discharge state by paying attention to that the charge and discharge states having same identification information have same tendency. Accordingly, it is possible that the charge and discharge control device 100 of the battery creates the charge and discharge control plan PL having the charge and discharge state which is estimated in the schedule time. Therefore, the charge and discharge control device 100 of the battery creates the charge and discharge control plan PL which has a high realization and suppresses the peak electricity more surely without disagreeing with the original introduction purpose of the battery.

In addition, in the charge and discharge control device 100 of the battery according to the fifth embodiment, the control plan creation unit may create the charge and discharge control plan PL with disregard to the charge and discharge state which is estimated, in a case that a peak electricity does not increase when occurring the charge and discharge state which is estimated in the first schedule time band in the charge and discharge control plan PL created without considering the charge and discharge state which is estimated. Therefore, it is possible that the charge and discharge control device 100 of the battery creates the charge and discharge control plan PL more flexibly when the influence does not occur in the peak electricity.

### Sixth Embodiment

The charge and discharge control device 100 of the battery according to the sixth embodiment estimates the charge and discharge states about the time before and after the schedule time in addition to the schedule time and creates the charge and discharge control plan PL having the charge and discharge states which are estimated. Before and after the schedule, a constant work such as the movement of the place with the schedule or the creation of the minutes may occur. Therefore, the charge and discharge control device 100 of the battery according to the sixth embodiment creates the charge and discharge control plan PL having a high possibility by estimating the charge and discharge state in the time before and after the schedule in total.

In the sixth embodiment, the hardware constitution and block configuration of the charge and discharge control device 100 of the battery are similar to that in the fifth embodiment (FIG. 5, FIG. 20), and are omitted to explain.

(Processes in the Sixth Embodiment)

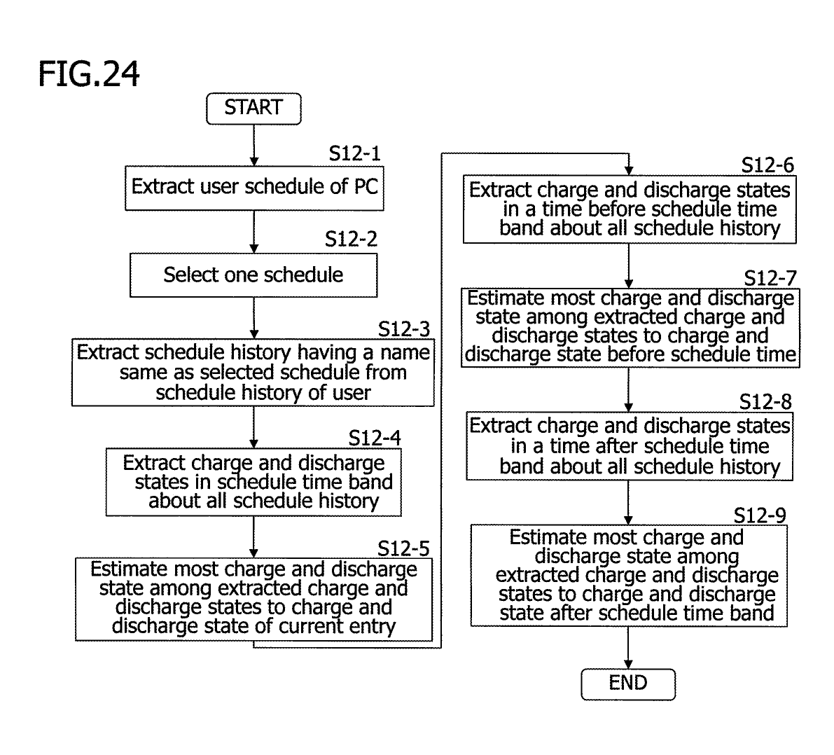

FIG. 24 is a diagram of a flow chart explaining processes of the charge and discharge control device 100 of the battery according to the sixth embodiment. A flow chart according to the sixth embodiment is same as that of the fifth embodiment depicted by FIG. 21 except the step S11. That is, the charge and discharge control device 100 of the battery according to the sixth embodiment execute the step S12 in substitution for the step S11 in FIG. 21. And the processes of the steps S12-1-S12-5 are similar to the steps S11-1˜S11-5 in FIG. 22 of the fifth embodiment.

In FIG. 24, the estimation unit 136 extracts the schedule of the user of the target notebook PC 30 during the period (in this example, a present day) that the charge and discharge control plan PL has been created from the schedule information PN (S12-1). Then, the estimation unit 136 selects one schedule among the schedules which are extracted (S12-2) and extracts a plurality of schedule histories which have same identification information as that of the selected schedule from the schedule information PN (S12-3). Then, the estimation unit 136 extracts the charge and discharge state in the schedule time about all of the schedule histories which are extracted (S12-4). And the estimation unit 136 estimates the charge and discharge state which is a most charge and discharge state among the charge and discharge states which are extracted, to the charge and discharge state which will occur in the scheduled time (S12-5).

Then the estimation unit 136 extracts the charge and discharge state at a predetermined time before the schedule time about the schedule history which is extracted (S12-6). And the estimation unit 136 estimates most charge and discharge state among the charge and discharge states which are extracted as the charge and discharge state at the predetermined time before the schedule time (S12-7). As similar, the estimation unit 136 extracts the charge and discharge state at a predetermined time after the schedule time about the schedule history which is extracted (S12-8). And the estimation unit 136 estimates most charge and discharge state among the charge and discharge states which are extracted as the charge and discharge state at the predetermined time after the schedule time (S12-9).

And the plan creation unit 133 creates the charge and discharge control plan PL having the estimated charge and discharge state in the schedule time and the time band before and after the schedule time, so that the peak electricity becomes small in consideration of an electricity demand prediction, specifications of each notebook PC 30, current charge and discharge state and battery residual quantity (S12-10).

The processes of the charge and discharge control device 100 of the battery according to the sixth embodiment that were illustrated by FIG. 24, will be explained based on a specific example. In the example, the predetermined time before and after the schedule time is thirty minutes, for example.

(Specific Example)

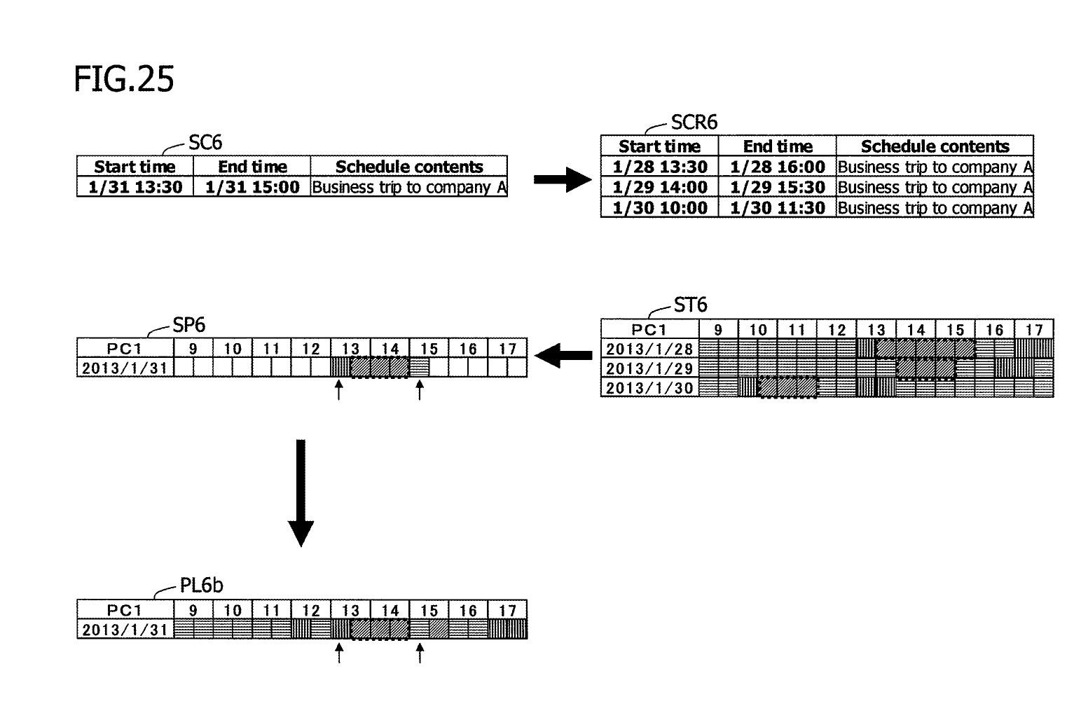

FIG. 25 is a diagram explaining a specific example of the process of the charge and discharge control device 100 of the battery according to the sixth embodiment. In FIG. 25, same portions as FIG. 4, FIG. 8A, FIG. 8B and FIG. 14A, FIG. 14B, FIG. 18A˜FIG. 18F and FIG. 23 are illustrated by same marks. In the example, a case, in which the charge and discharge control device 100 creates the charge and discharge control plan PL at the time 2013/1/31, will be explained. FIG. 25 illustrates examples of the schedule list SC6 of the user 1 which utilizes the PC1 at 2013/1/31, the schedule history SCR6 of the user 1, the charge and discharge state history table ST6 of the PC1, the estimation information SP6, and the charge and discharge control plans PL6b.

As similar to the fifth embodiment, the estimation unit 136 selects a schedule “from 13:30 to 15:00: a business trip to company A” from the schedule list SC6 of 2013/1/31 of the User1 in FIG. 25 (S12-2). In addition, the estimation unit 136 extracts three schedule histories “2013/1/28 from 13:30 to 16:00”, “2013/1/29 from 14:00 to 15:30”, and “2013/1/30 from 10:00 to 11:30” from the schedule history SCR6 of the User1 (S12-3). In the charge and discharge state history table ST6 in FIG. 25, all charge and discharge states of the schedule history which are extracted are the electric discharge state BA (S12-4). Therefore, the estimation unit 136 estimates that the charge and discharge state for 2013/1/31 from 13:30 to 15:00 of the PC1 is the electric discharge state BA (S12-5).

Then, the estimation unit 136 extracts the charge and discharge state in 30 minutes before each of the schedule histories which are extracted (S12-6). Because the charge and discharge states which are extracted are two charge state CH and one electricity state AC, the estimation unit 136 estimates the charge and discharge state for 2013/1/31 from 13:00 to 13:30 to be the charge state CH as illustrated in the estimated information SP6 of FIG. 25 (S12-7). In addition, the estimation unit 136 extracts the charge and discharge state (all electricity state AC in the example) in 30 minutes after each of the schedule histories which are extracted (S12-8). Therefore, the estimation unit 136 estimates the charge and discharge state for 2013/1/31 from 15:00 to 15:30 to be the electricity state AC as illustrated in the estimated information SP6 of FIG. 25.

And the estimation unit 133 creates the charge and discharge control plan PL6b appointed the electric discharge state BA from 13:30 to 15:00, the charge state CH, from 13:00 to 13:30 and the electricity state AC, from 15:00 to 15:30 of 2013/1/31 of the PC1, so that the peak electricity becomes small (S2-2). In addition, the battery drive is difficult when from 13:30 to 15:00 the battery residual quantities of the PC1 are few. Therefore, the plan creation unit 133 creates the charge and discharge control plan PL6b that the PC1 maintains enough battery residual quantities in a time at 13:30 by appointing the charge state CH from 12:00 to 12:30 when the electricity demand prediction is few in the charge and discharge control plan PL6b.

In addition, the predetermined time before and after the schedule time is exemplified a case that is 30 minutes in the example. However, the predetermined time may not be limited to this example, such as be at other time, and be the time when the charge and discharge state, which is estimated before and after the schedule time, continues. In the embodiment, in both schedule histories, the electricity state AC continues for 60 minutes after the schedule time. Therefore, the charge and discharge control device 100 of the battery estimates that the electricity state AC continues, for example, for 60 minutes after the schedule time, and may create the charge and discharge control plan PL6b appointing the electricity state AC from 15:00 to 16:00.

As described above, in the charge and discharge control device 100 of the battery according to sixth embodiment, the estimation unit estimates the charge and discharge state in the time of either one or both of before and after schedule time in addition to the charge and discharge state in the first schedule time. Thereby, it is possible that the charge and discharge control device 100 of the battery creates the charge and discharge control plan PL having the charge and discharge state in the time before and after schedule time in addition to the charge and discharge state in the schedule time. the device 100 of the battery Because the movement of the place and the constant work with the schedule may occur before and after schedule time, it is possible that the charge and discharge control device 100 of the battery, by estimating the charge and discharge state in the time before and after schedule time in addition to the charge and discharge state in the schedule time, creates the charge and discharge control plan PL with a high possibility and suppresses the peak electricity more surely.

### Seventh Embodiment

The schedule start time and end time, since a business trip or a meeting are prolonged or moved forward, for example, may be different from the fact. When carrying the notebook PC 30 depending on the schedule, at the real schedule start time and end time, the charge and discharge state may change. The charge and discharge control device 100 of the battery according to seventh embodiment corrects the schedule start time and end time based on a history of the charge and discharge state. It is possible that the charge and discharge control device 100 of the battery creates the charge and discharge control plan PL having a higher possibility by correcting the schedule start time and end time.

In the seventh embodiment, the hardware constitution and block configuration of the charge and discharge control device 100 of the battery are similar to that in the fifth embodiment (FIG. 5, FIG. 20), and are omitted to explain.

(Processes in the Seventh Embodiment)

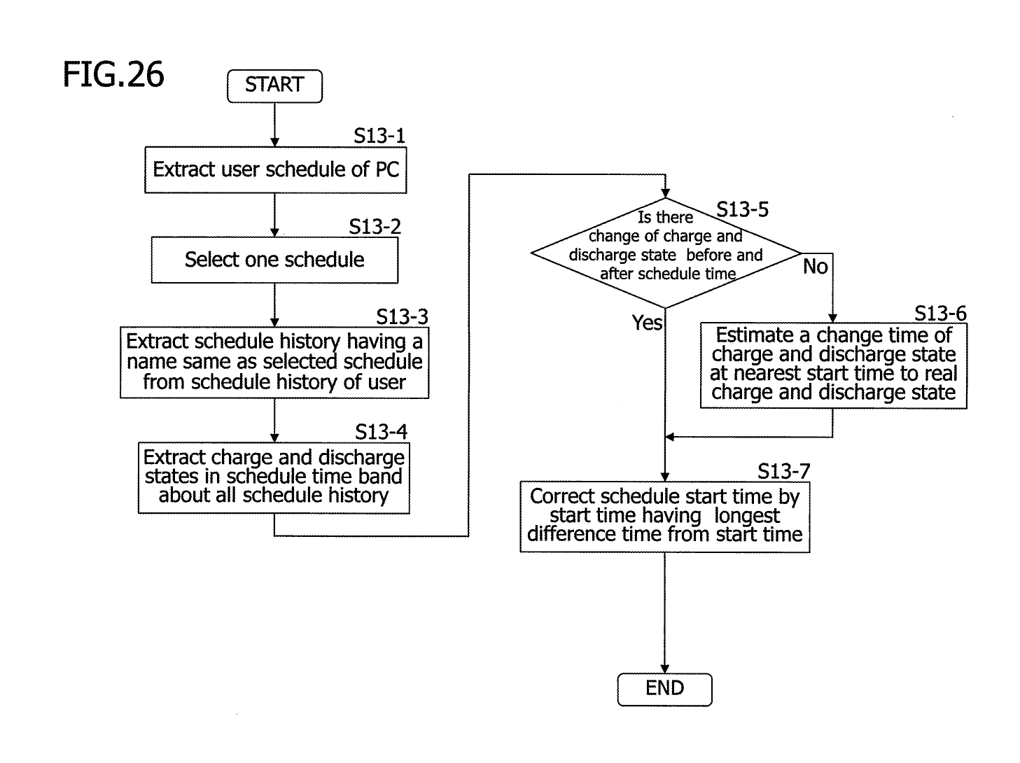

FIG. 26 is a diagram of a flow chart explaining processes of the charge and discharge control device 100 of the battery according to the seventh embodiment. A flow chart according to the seventh embodiment is same as that of the fifth embodiment depicted by FIG. 21 except the step S11. That is, the charge and discharge control device 100 of the battery according to the seventh embodiment execute the step S13 in substitution for the step S11 in FIG. 21. And the processes of the steps S13-1-S13-5 are similar to the steps S11-1-S11-5 in FIG. 22 of the fifth embodiment.

In FIG. 26, the estimation unit 136 extracts the schedule history SCR7 of the user of the target notebook PC 30 during the period (in this example, a present day) that the charge and discharge control plan PL has been created from the schedule information PN (S13-1). Then, the estimation unit 136 selects one schedule among the schedules which are extracted (S13-2) and extracts a plurality of schedule histories which have same identification information as that of the selected schedule from the schedule information PN (S13-3). Then, the estimation unit 136 extracts the charge and discharge states in the schedule time and the time before and after the schedule time about all of the schedule histories which are extracted (S13-4).

And the estimation unit 136 determines that the start time of the schedule history is same as registered one, when the charge and discharge states are changed before and after the start time based on the extracted charge and discharge states (YES/S13-5), and estimates the registered start time to actual start time. While, when the charge and discharge states are not changed before and after the schedule time (NO/S13-5), and estimates the time in which the charge and discharge states are changed in nearest time as the start time to actual start time (S13-6). For example, the estimation unit 136 regards that the target time band which is detected the change of the charge and discharge state is between from the time of duration before the start time to the end time. When the charge and discharge states do not change between the target time bands, the estimation unit 136 considers that the charge and discharge states do not change by the schedule and determines that the start time of the schedule history is as same as registration.

And the estimation unit 136 determines selected schedule difference time to longest difference time among the difference times between estimated schedule start time in the extracted schedule history and the start time which are registered, and corrects the start time (S13-7). In addition, the estimation unit 136 may correct the start time by determining the average of the difference time to the selected schedule difference time. In addition, the estimation unit 136 may correct the schedule start time only based on the schedule history, which has same day of week and time band as selected schedule, among the schedule histories which are extracted. For example, the estimation unit 136 executes same processes S13-5-S13-7 about the end time.

The processes of the charge and discharge control device 100 of the battery according to the seventh embodiment that were illustrated by FIG. 26, will be explained based on a specific example.

(Specific Example)

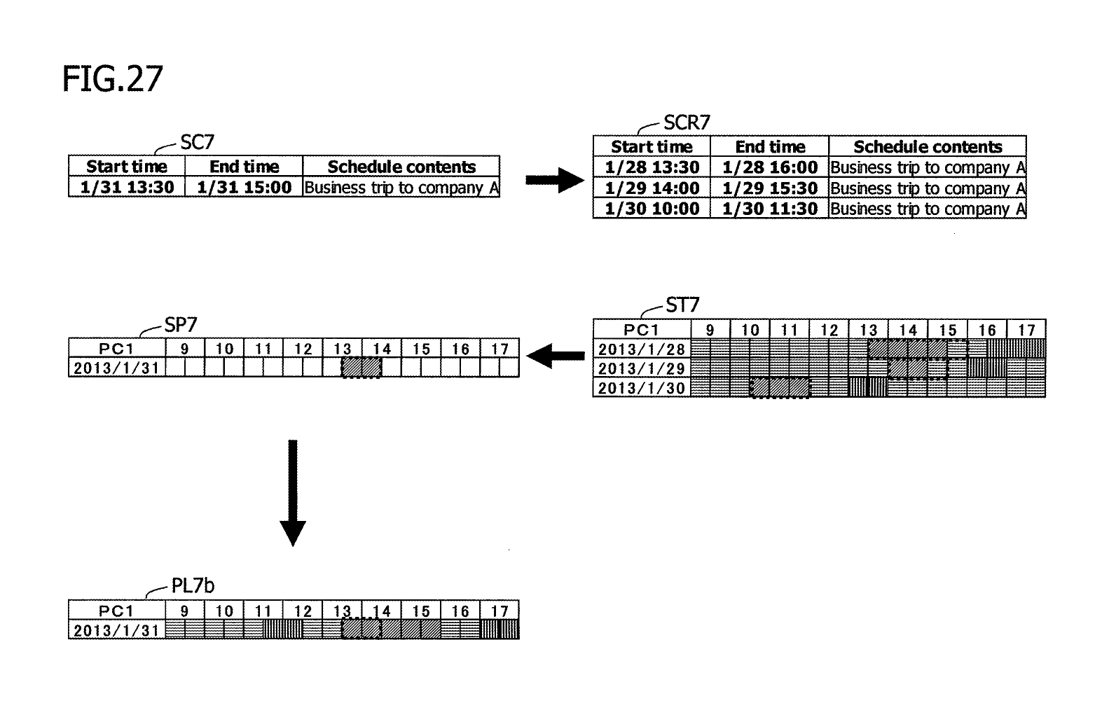

FIG. 27 is a diagram explaining a specific example of the process of the charge and discharge control device 100 of the battery according to the seventh embodiment. In FIG. 27, same portions as FIG. 25 are illustrated by same marks. In the example, a case, in which the charge and discharge control device 100 creates the charge and discharge control plan PL at the time 2013/1/31, will be explained. FIG. 27 illustrates examples of the schedule list SC7 of the user 1 which utilizes the PC1 at 2013/1/31, the schedule history SCR7 of the user 1, the charge and discharge state history table ST7 of the PC1, the estimation information SP7, and the charge and discharge control plans PL 7b.

As similar to the fifth and sixth embodiments, the estimation unit 136 selects a schedule “from 13:30 to 15:00: a business trip to company A” from the schedule list SC7 of 2013/1/31 of the User1 in FIG. 27 (S13-2). In addition, the estimation unit 136 extracts three schedule histories “2013/1/28 from 13:30 to 16:00”, “2013/1/29 from 14:00 to 15:30”, and “2013/1/30 from 10:00 to 11:30” from the schedule history SCR 7 of the User1 (S13-3).

In the charge and discharge state history table ST7 in FIG. 27, the charge and discharge state in the time of the schedule history of the PC1 changes into the electric discharge state BA from the electricity state AC before and after the start time except “2013/1/28”. Therefore, the estimation unit 136 does not correct the schedule start time. On the other hand, the charge and discharge state in the schedule histories of “2013/1/28” and “2013/1/29” do not change before and after the end time about the schedule end time (NO/S13-5), and the charge and discharge state changes before 30 minutes of the end time (S13-6). In addition, the charge and discharge state of the schedule history “2013/1/30” of the PC1 changes at 30 minutes after the end time (NO/S13-5, S13-6). Therefore, the estimation unit 136 corrects the schedule end time from 15:00 to 14:30, as illustrated in the estimated information SP7 of FIG. 27, based on the schedule histories of “2013/1/28” and “2013/1/29” (S13-7).

And the plan creation unit 133 creates the charge and discharge control plan PL7b appointed the electric discharge state BA which is estimated from 13:30 to 14:30 of 2013/1/31 of the PC1, so that the peak electricity becomes small (S2-2). In addition, the charge and discharge control device 100 of the battery, for example, may correct the schedule start time and end time based on a schedule history of the day before at every morning. In addition, the charge and discharge control device 100 of the battery executes the correction process based on the corrected start time and end time in the schedule time.

As described above, the charge and discharge control device 100 of the battery according to the seventh embodiment, corrects the time in which the charge and discharge state is changed in the time including the time band before and after the first schedule time as the start time or the end time of the first schedule. It is possible to estimate the charge and discharge state in the schedule time more highly precise, because the charge and discharge control device 100 of the battery corrects the schedule start time and end time at a more correct time. Therefore, it is possible to create the charge and discharge control plan PL having a higher possibility and to suppress the peak electricity more surely.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A device of controlling a charge and discharge of a battery, the device comprising:
a storing device configured to store a plurality of charge and discharge control plans which define the charge and discharge state including a discharge state, an electricity state and a charge state of the battery in each of time bands, and an unplanned use history list including an unplanned use entry which has duration time and the charge and discharge state when the unplanned use occurs; and
a control device configured to acquire the charge and discharge state of a first battery, compare acquired charge and discharge state with the charge and discharge state defined in the charge and discharge control plan, detect a first unplanned use when the acquired charge and discharge state is different from the charge and discharge state defined in the charge and discharge control plan, estimate duration time and charge and discharge state of the first unplanned use based on the unplanned entry which is corresponding to the first unplanned use and is stored in the unplanned use history list, correct the charge and discharge control plan of the first battery so as to have the estimated charge and discharge state in estimated duration time of the first unplanned use, and correct the charge and discharge control plan of a second battery, which has the estimated charge and discharge state in the estimated duration time, corresponding to correction of the charge and discharge control plan of the first battery.

2. The device according to claim 1, wherein the control device is configured to correct the charge and discharge control plan of the second battery so that a first peak electricity based on the plurality of charge and discharge control plans which includes corrected charge and discharge control plans of the first and second batteries does not exceed a second peak electricity based on the plurality of charge and discharge control plans which includes the charge and discharge control plans of the first and second batteries before correction, or does not exceed a predetermined limit value.

3. The device according to claim 1, wherein the control device is configured to correct the charge and discharge state in time band except the estimated duration time in the charge and discharge control plan of the first battery so as to perform controlling the estimated charge and discharge state in the estimated duration time.

4. The device according to claim 1, wherein the control device is configured to estimate the duration time and the charge and discharge state based on the unplanned use entry in the unplanned use history list, the unplanned use entry being the charge and discharge state which is acquired and the charge and discharge state appointed by the discharge control plan are same as the first unplanned use at the time of detection.

5. The device according to claim 1, wherein the second battery is a battery that the unplanned use does not occur in a predetermined time including the duration time of the first unplanned use.

6. The device according to claim 1, wherein the control device is configured to detect the first unplanned use which will occur after a predetermined time based on the unplanned use entry of the first battery which the charge and discharge state of the first battery, which is acquired, and the charge and discharge state in the predetermined time before a start time of the unplanned use are same.

7. The device according to claim 1, wherein the storing device is configured to further store a schedule of the user of the first battery, and
the control device is configured to extract one or more second schedule histories in which identification information is same as first schedule, and detects the first unplanned use which occurs corresponding to the first schedule based on the unplanned use entry corresponding to the second schedule histories which are extracted.

8. The device according to claim 7, wherein the control device is configured to detect the first unplanned use when all charge and discharge states in the time band of the second schedule history are the discharge state even when the unplanned use entry is not detected, and estimate the charge and discharge state of the first unplanned use as the charge and discharge state.

9. The device according to claim 7, wherein the control device is configured to prohibit a detection of the first unplanned use when the unplanned use entry is not detected and the charge and discharge state in the time band of the second schedule history includes all kinds of the charge and discharge states.

10. The device according to claim 7, wherein the control device is configured to correct the charge and discharge control plan of the first battery so as to have the charge and discharge state except the charge and discharge state which is estimated in the first schedule time band so as not to exceed a peak electricity when correcting the charge and discharge control plan so as to have the charge and discharge state which is estimated in the duration time of the first unplanned use which is extracted, and delete the unplanned use entry corresponding to the first unplanned use when the unplanned use is not detected in the first schedule time band and prohibit a extraction of the unplanned use of the second schedule when the first schedule is detected as schedule having same identification information as the second schedule.

11. The device according to claim 1, wherein the control device is configured to prohibit the correction of the charge and discharge control plan in a case that a peak electricity, when occurring the charge and discharge state which is estimated in the duration time of the first unplanned use which is estimated in the first battery based on the charge and discharge control plan of the first battery, does not exceed a peak electricity when the charge and discharge control plan of the first battery is not corrected.

12. The device according to claim 1, wherein the control device is configured to create the plurality of charge and discharge control plans so that a peak electricity based on the plurality of charge and discharge control plan is small, and create the charge and discharge control plan of the first battery so as to have the charge and discharge state which is estimated in the duration time of the first unplanned use which is estimated.

13. The device according to claim 12, wherein the storing device is configured to further store a schedule of the user of the first battery, and
the control device is configured to estimate the charge and discharge state in first schedule time band of the first battery based on the charge and discharge states in time bands of one or more second schedule histories in which an identification information is same as the first schedule, and create the charge and discharge control plan of the first battery so as to have the charge and discharge state which is estimated in the first schedule time band.

14. A device of controlling a charge and discharge of a battery, the device comprising:
a storing device configured to store a plurality of charge and discharge control plans which define the charge and discharge state including a discharge state, an electricity state and a charge state of the battery in each of time bands, and a schedule of an user of the battery; and
a control device configured to acquire the charge and discharge state of a first battery, estimates charge and discharge state in a time band of a first schedule of the first battery based on the charge and discharge state in a time band of one or more second history which identification information is same as the first schedule, and create the charge and discharge control plans of the plurality of batteries so that a peak consumption power based on the charge and discharge control plans is small and so that charge and discharge control plan of the first battery has the charge and discharge state which is estimated in the first schedule time band.

15. The device according to claim 14, wherein the control unit is configured to create the charge and discharge control plan having the discharge state in the first schedule time band when the charge and discharge state which is estimated is the discharge state, and having the charge and discharge state of either one of the electricity state and the charge state in the first schedule time band when the charge and discharge state which is estimated is the charge and discharge state except the discharge state.

16. The device according to claim 14, wherein the control unit is configured to create the charge and discharge control plan without considering the charge and discharge state which is estimated, in a case that a peak electricity does not increase when occurring the charge and discharge state which is estimated in the first schedule time band in the charge and discharge control plan created without considering the charge and discharge state which is estimated.

17. The device according to claim 14, wherein the control unit is configured to estimate the charge and discharge states in either one or both of time bands before and after the first schedule time band.

18. The device according to claim 14, wherein the control unit is configured to correct the start time or end time of the first schedule to a time of changing the charge and discharge states in time band including time before or after the first schedule time band.

19. The device according to claim 1, wherein the control unit is configured to control the batteries based on the charge and discharge control plan.

20. A method of controlling a charge and discharge state of a plurality of batteries, the method comprising:
acquiring a charge and discharge state, which includes a charge state, an electricity state and a discharge state, of the battery;
comparing acquired charge and discharge state with a charge and discharge state defined in a charge and discharge control plan;
detecting a first unplanned use when the acquired charge and discharge state is different from the charge and discharge state defined in the charge and discharge control plan;
estimating duration time and charge and discharge state of the first unplanned use based on the unplanned use entry corresponding to the first unplanned use in the unplanned use history list of the first battery; and
correcting the charge and discharge control plan of the first battery so as to have the estimated charge and discharge state in estimated duration time of the first unplanned use and correcting the charge and discharge control plan of a second battery, which has the estimated charge and discharge state in the estimated duration time, corresponding to correction of the charge and discharge control plan of the first battery.
